(19) United States
(12) Patent Application Publication
(10) Pub. No.: US 2026/0316292 A1
(43) Pub. Date: Oct. 15, 2026

(54) PROPRIOCEPTION SYSTEM FOR A HUMANOID ROBOT

(71) Applicant: Figure AI Inc., San Jose, CA (US)

(72) Inventors: Christopher Stathis, San Jose, CA (US); Louis Foucard, San Jose, CA (US); Hao Wu, San Jose, CA (US); Oscar Ramirez, San Jose, CA (US); Alonso Marco-Valle, San Jose, CA (US)

(21) Appl. No.: 19/550,067

(22) Filed: Feb. 25, 2026

Related U.S. Application Data
(60) Provisional application No. 63/763,209, filed on Feb. 25, 2025.

(51) Int. Cl. B25J 13/08; B25J 9/16

(52) U.S. Cl. CPC B25J 13/089; B25J 9/162; B25J 9/1653; B25J 9/1697

(57) ABSTRACT

A method and system for determining the position and orientation of parts and components of a humanoid robot using a body self-perception model (BSPM). The BSPM executes on onboard processors and receives image data from cameras mounted in the robot's head and on or near its hands. The BSPM processes the image data to detect and localize keypoints on the robot's own components and determines six-degree-of-freedom poses therefrom. The determined poses are provided to an onboard AI system that generates motor commands in a closed-loop control cycle. The BSPM may dynamically weight keypoint-based and holistic pose estimation based on occlusion degree, express poses using a delta SE(3) representation, and output uncertainty estimates that modulate control behavior. The system may fuse camera data with data from inertial measurement units, joint encoders, or other sensor modalities to produce position estimates exceeding the accuracy achievable by any single sensor alone.

### CROSS-REFERENCE TO RELATED APPLICATIONS

This application claims the benefit of and priority to U.S. Provisional Patent Application Nos. 63/763,209, filed on Feb. 25, 2025, which is fully incorporated herein by reference.

### TECHNICAL FIELD

The present disclosure relates to robotic systems, and more particularly to a proprioception system for humanoid robots that enables efficient and scalable deployment in dynamic environments.

### BACKGROUND

A humanoid robot is a machine built in the shape of a human body, with a head, a torso, two arms, two hands, two legs, and two feet. Like a person, the robot must know where its own body parts are in space in order to move them with purpose and precision. When a person reaches for a cup, the person's brain continuously tracks where the hand is and guides it to the cup. A humanoid robot faces the same challenge: it must determine the position and orientation of its own parts and components—its hands, fingers, arms, legs, and feet—- and use that knowledge to control their movement in real time.

Existing approaches to this challenge rely on Proprioceptive sensors, including joint encoders and inertial measurement units (IMUs), to estimate where the robot's structural components are located within a defined coordinate space. However, each individual sensing modality is subject to inherent limitations that constrain its standalone utility. Encoders provide high-resolution angular measurements at the joint axis yet cannot account for structural compliance, link-side deformation, cable stretch, or transmission backlash that arises beyond their sensing axis. IMUs deliver high-bandwidth orientation data at update rates exceeding several hundred hertz but suffer from gyroscope bias drift that progressively corrupts position estimates over time, rendering them unreliable for sustained absolute positioning without periodic correction. Neither modality alone provides a complete or drift-free characterization of the robot's spatial state across all degrees of freedom.

Vision-based approaches using traditional computer vision techniques, such as hand-crafted feature detectors, geometric template matching, or classical stereo correspondence algorithms, may be sensitive to lighting variation, specular reflections, occlusion, background clutter, and changes in the robot's visual appearance due to surface wear, panel replacement, or accumulation of debris. These sensitivities limit the reliability of conventional vision-based positioning across the diverse and unpredictable conditions encountered during real-world operation. Furthermore, traditional vision pipelines often lack the capacity to generalize across different robot morphologies or to recover gracefully from partial occlusion of tracked components. As such, there is therefore a need for a learned spatial perception system that is trained on data specific to the robot's own morphology, that operates continuously during task execution, and that fuses heterogeneous sensor data to maintain an accurate and robust estimate of the robot's spatial state across varying environmental conditions and operational phases.

### SUMMARY

A method and system for determining the position and orientation of parts and components of a humanoid robot are disclosed. A body self-perception model (BSPM) executes on one or more processors of the humanoid robot and receives image data from a plurality of vision sensors mounted on the humanoid robot, including at least a first camera mounted in a head of the humanoid robot and a second camera mounted on or near a hand of the humanoid robot. The BSPM processes the image data to detect and localize a plurality of keypoints on the parts and components of the humanoid robot, wherein each keypoint corresponds to a visually distinguishable feature on a component or around a joint. From the detected keypoints, the BSPM determines a six-degree-of-freedom pose comprising a position and an orientation for each of one or more tracked parts or components. The determined pose is provided to an onboard AI system that generates motor commands for controlling the position and movement of the parts and components in a closed-loop control cycle. The BSPM may determine the pose using a weighted combination of keypoint-based estimation and holistic pose estimation, with the weighting dynamically adjusted based on a degree of occlusion. The BSPM may express the determined pose using a delta SE(3) pose representation and may output an uncertainty estimate that the onboard AI system uses to modulate control actions. The humanoid robot system may further comprise one or more additional sensors of a different modality than the vision sensors, such as inertial measurement units, joint encoders, time-of-flight sensors, or event-based vision sensors. The BSPM may fuse the image data with sensor data from the one or more additional sensors using a sensor fusion algorithm to produce a fused position estimate having an accuracy exceeding what either the image data or the sensor data alone can achieve, and the fused position estimate is delivered to the onboard AI system for motor command generation. A method for controlling movement of a finger assembly of the humanoid robot is also disclosed, in which the BSPM obtains inertial measurement data from a first inertial measurement unit mounted on a first articulated segment of the finger assembly and from a second inertial measurement unit mounted on a second articulated segment of the finger assembly, fuses the first and second inertial measurement data to reconstruct a kinematic chain of the finger assembly relative to a gravity vector and a palm reference frame, determines a position and orientation of a fingertip, and provides the determined position and orientation to the onboard AI system for generating motor commands that control movement of the finger assembly.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 is a high-level block diagram illustrating data inputs and outputs of a bipedal spatial perception model (BSPM);

FIG. 10A is a robot's perspective view of the end effector when said humanoid robot is in the first pose;

FIG. 10B is a zoomed-in view of FIG. 10A, wherein a plurality of keypoints are shown on the end effector in the first location;

FIG. 11 is a first-person view of an end effector, wherein an estimated pose of the robot component, as determined by the second embodiment of the BSPM, is overlaid thereon;

FIG. 12 is a diagram of an example use case where the BSPM is deployed on humanoid robots for package handling and sorting in logistics, which involves transferring packages from one conveyor belt to another while also ensuring the shipping label of each package is oriented for scanning;

FIG. 13 is a flowchart illustrating an example sensor fusion process that combines IMU and camera data for determining the position of components of the humanoid robot;

FIG. 14 is a flowchart illustrating an example sensor fusion process that combines joint encoder and camera data, with a specific use case on finger pose estimation data; and

FIG. 15 is a flowchart illustrating a sensor fusion process that combines data from three different sensor types including IMU, encoder, and camera, to estimate the pose of certain components of the humanoid robot of FIGS. 1-3B, wherein the fusion algorithms may be designed to exploit the complementary characteristics of different sensor modalities.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

A humanoid robot that cannot determine where its own hand is in space is, in every practical sense, blind. It may possess dozens of actuators and an advanced onboard computer, yet without a continuous and accurate understanding of the position and orientation of its own limbs, fingers, and joints, it cannot thread a needle, transfer a package between conveyor belts, or walk across a room without stumbling. The challenge of self-perception-knowing, in real time, precisely where each part of one's own body is located and in which direction it is facing—is one that humans solve effortlessly through a combination of vision, proprioception, and vestibular feedback. For robots, and for humanoid robots in particular, replicating this capability has proven to be a persistent engineering problem whose conventional solutions carry significant penalties in cost, weight, mechanical complexity, and vulnerability to failure.

The conventional approach to spatial self-awareness in robotics relies on embedding dedicated sensors at each joint and component. Rotary encoders measure angular displacement at motor shafts, strain gauges detect deformation in structural members, and torque sensors monitor the forces transmitted through drivetrains. Each of these sensors adds physical mass and volume to the joint or limb on which it is mounted, an especially acute constraint in the compact, densely packaged joints of a humanoid hand, where the difference between a functional finger and an inoperable one may come down to a few cubic millimeters of available space. Beyond the packaging problem, each additional sensor introduces its own wiring, connector, and signal-conditioning electronics—each a potential point of failure that can take an entire limb offline if a single solder joint fractures or a cable fatigues after thousands of repeated flexion cycles. The reliability problem compounds across the dozens of joints in a full humanoid body, where the probability that at least one sensor will degrade or fail during an extended deployment grows with every added sensing element. Furthermore, many of these sensors measure only a single degree of freedom (such as rotation about a single axis) and provide no information about structural deformations, backlash in gear trains, or link-side deflections that occur between the sensor and the point of interest, leaving the robot's internal model of itself subtly but persistently inaccurate in ways that accumulate over long kinematic chains.

The disclosure that follows addresses these limitations through a fundamentally different approach: a learned body self-perception model, referred to throughout as the BSPM, that enables a humanoid robot to determine the position and orientation of its own parts and components by looking at itself with its own cameras. The BSPM is an integrated neural control architecture whose perception engine may be built upon a multi-scale feature extraction backbone-such as a convolutional neural network, a vision transformer, or an SE(3)-equivariant network-designed to extract semantically rich features while maintaining robustness to viewpoint and orientation variations. Rather than instrumenting every joint and link with dedicated hardware, the BSPM processes image data from cameras mounted in the robot's head and on or near its hands to detect visually distinguishable features-termed keypoints-on the robot's surfaces, joints, and end effectors. These keypoints may be physical features such as the center of a screw head, the corner of a rectangular cutout, or the endpoint of a groove, and they may also include micro-scale fiducial patterns printed in ultraviolet-fluorescent ink that are invisible to the human eye but detectable by the robot's cameras under ultraviolet illumination. From the detected keypoints, the BSPM computes full six-degree-of-freedom poses-meaning the complete position and orientation—of each tracked component, expressing those poses in a mathematical framework called the Lie algebra SE(3) that avoids the singularities and discontinuities that plague simpler rotation representations. The result is a spatial description of the robot's body that is precise enough to guide the insertion of a fastener into a tight-tolerance receptacle, yet general enough to track gross limb movements during walking or running.

The training and refinement of the BSPM draw on a hybrid data generation pipeline that synthesizes real-world sensory observations with high-fidelity computer-aided design simulations and finite element analysis, producing a comprehensive training manifold that accounts for mechanical deformations, structural compliance, and varied environmental occlusions. To ensure operational longevity across a fleet of robots, the system may incorporate federated learning for decentralized knowledge sharing across a plurality of robotic units and meta-learning for rapid few-shot adaptation to hardware modifications or limb replacements-so that when a robot receives a new hand or a replacement forearm panel, the BSPM can recalibrate to the altered appearance and geometry with minimal additional training data. A physics-based differentiable kinematic layer may be integrated into the neural architecture to enforce hard physical constraints, such as joint travel limits and center-of-mass stability, ensuring that all perceived poses are anatomically and physically plausible rather than artifacts of neural network hallucination. Through a life-long learning framework, the system continuously monitors the statistical consistency between visual, inertial, and encoder data streams, applying online fine-tuning to compensate for nonlinear disturbances such as cable stretch, thermal expansion of metal frames, or gradual component wear, thereby sustaining high-fidelity accuracy throughout the robot's operational lifecycle.

The BSPM does not merely detect where components are; it also quantifies how much it trusts each estimate. Alongside every computed pose, the model outputs an uncertainty measure in the form of a covariance matrix that captures how confident the estimate is in each spatial direction. The robot's onboard AI system consumes this uncertainty information to calibrate its own behavior: when the pose estimate is highly certain, the AI system issues decisive, high-velocity motor commands; when uncertainty is elevated-perhaps because a hand is partially hidden behind an object being grasped—the AI system slows down, moves more cautiously, and may select an alternative motion plan that routes through regions of the workspace where the cameras have better visibility. This uncertainty-aware control loop transforms what would otherwise be a brittle open-loop trajectory into a robust, self-regulating feedback system that degrades gracefully in the face of occlusion, poor lighting, or rapid motion. The BSPM further enriches the control signal by computing the velocity and acceleration of each tracked component from temporal sequences of images, enabling the onboard AI system to predict where a component will be a fraction of a second from now and to issue anticipatory motor commands rather than reacting to stale position data.

The vision-based approach alone, however, does not address every operating condition a humanoid robot may encounter. Cameras operate at frame rates that, while sufficient for most tasks, cannot capture the microsecond-level dynamics of a finger snatching a falling tool or a foot slipping on a wet surface. To close this gap, the BSPM implements sensor fusion algorithms that blend camera-derived position data with data from one or more complementary sensor modalities-inertial measurement units, joint encoders, time-of-flight depth sensors, thermal imagers, structured-light projectors, radar, ultrasonic sensors, and event-based neuromorphic cameras—each selected for the specific physical information it contributes. Inertial measurement units mounted on individual finger segments, for instance, provide orientation and angular velocity updates at rates of five hundred to one thousand hertz with sub-millisecond latency, capturing rapid transients that cameras would miss, while the cameras provide drift-free absolute position references that prevent the inertial estimates from wandering over time. The fusion of these complementary signals is accomplished through estimation frameworks such as extended Kalman filters and factor graph optimizers that maintain a unified state vector for each tracked component and update it at the native rate of each sensor, producing a final position estimate whose accuracy exceeds what any single sensor could achieve on its own. To maintain computational efficiency on embedded hardware, the system may employ precomputed Kalman gains or steady-state approximations that eliminate complex matrix inversions during real-time operation, and the BSPM may be deployed as a distributed processing framework that uses high-capacity remote systems for batch updates and model retraining while running lightweight, quantized versions on local robotic hardware for low-latency inference.

A distinctive feature of the disclosed system is its capacity for self-correction without external intervention. The BSPM continuously cross-validates the estimates produced by each sensor modality against the others, using the camera-derived pose as the long-term ground truth against which inertial drift and encoder backlash are measured and corrected. When the system detects that an inertial measurement unit has drifted beyond a configurable threshold, it automatically recalibrates the unit's bias parameters using the camera-based reference; when it observes that the position predicted by a joint encoder no longer matches the position seen by the cameras, it attributes the discrepancy to mechanical wear, thermal expansion, or gear backlash and updates its kinematic model accordingly. The three-way fusion of cameras, inertial measurement units, and joint encoders also functions as a diagnostic gateway: if both the inertial and encoder data streams maintain internal consistency yet deviate from the visual observation, the system can infer a potential misalignment of a camera housing or a shift in extrinsic parameters and execute a positioning routine that uses the combined inertial and encoder data as a reference to update the camera's extrinsic transformation matrices. This self-correcting loop allows the robot to maintain sub-millimeter positioning accuracy over hours of continuous operation without returning to a calibration fixture, and it generates trend data that maintenance personnel can use to schedule preventive service before a degrading component causes an operational failure. The triple-redundant architecture provides formal fault detection: disagreement in any two-sensor pair, while the third sensor agrees with one member of the pair, isolates the faulty sensor and allows the system to continue operating on the healthy sensors with a quantified increase in estimation uncertainty rather than a hard stop.

The system's treatment of the humanoid hand illustrates these principles at their most demanding scale. Each finger comprises multiple articulated segments-proximal, medial, and distal-connected by joints so small that traditional encoders are difficult or impossible to package within them. The disclosed approach places a compact inertial measurement unit on each segment, fuses the data from adjacent units to reconstruct the kinematic chain of the finger relative to the palm, and combines the result with camera observations from head-mounted and wrist-mounted cameras to produce a fingertip position estimate that is both fast enough to catch a slipping object and accurate enough to guide the assembly of miniature mechanical components. Where encoders are present, the system exploits the difference between the motor-side angle measured by the encoder and the link-side orientation measured by the inertial unit to estimate the compliance deflection of the transmission- and from that deflection, the joint torque-without installing a dedicated torque sensor, effectively turning the combination of an encoder and an inertial unit into a virtual force sensor. When encoders are absent or when the fingers are occluded from the cameras' line of sight, the system falls back to a hierarchical logic in which the encoder-based or IMU-based kinematic chain maintains state estimation during the period of visual obstruction, and a predictive kinematic model propagates the last known finger pose forward in time using commanded motor currents and a learned relationship between current and joint velocity. This virtual sensing and predictive fallback capability allows the robot to detect unexpected contacts, modulate grip force during delicate manipulation, and monitor the health of its own drivetrains by tracking changes in backlash width over time.

Taken together, the technologies disclosed herein represent a shift in the architecture of humanoid robot proprioception—from a paradigm in which every degree of freedom demands its own dedicated sensor to one in which a learned perception model, operating on data from a small number of cameras and inertial units, can recover the full spatial state of a complex articulated body in real time. The resulting system is lighter, less expensive, more mechanically reliable, and more adaptable to new body configurations than conventional sensor-dense designs, while achieving positioning accuracy that meets or exceeds the demands of industrial manipulation, package handling, domestic assistance, and unstructured outdoor locomotion. The pages that follow describe, in full technical detail, the architecture of the BSPM, the keypoint detection and pose estimation methods it employs, the sensor fusion algorithms that enhance its accuracy and robustness, and the closed-loop control framework through which the onboard AI system translates the BSPM's spatial estimates into the motor commands that bring the robot's body to life.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

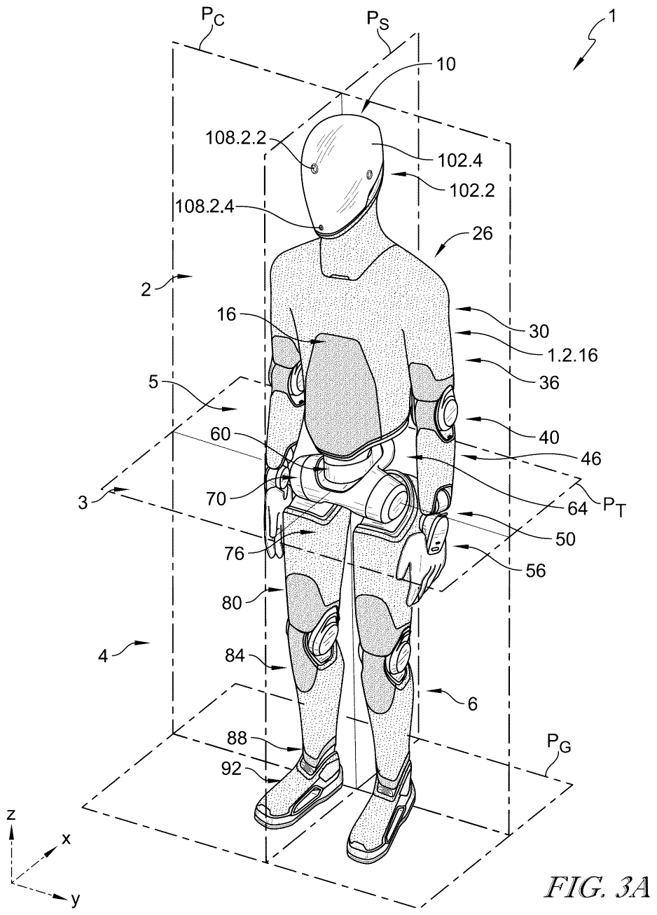

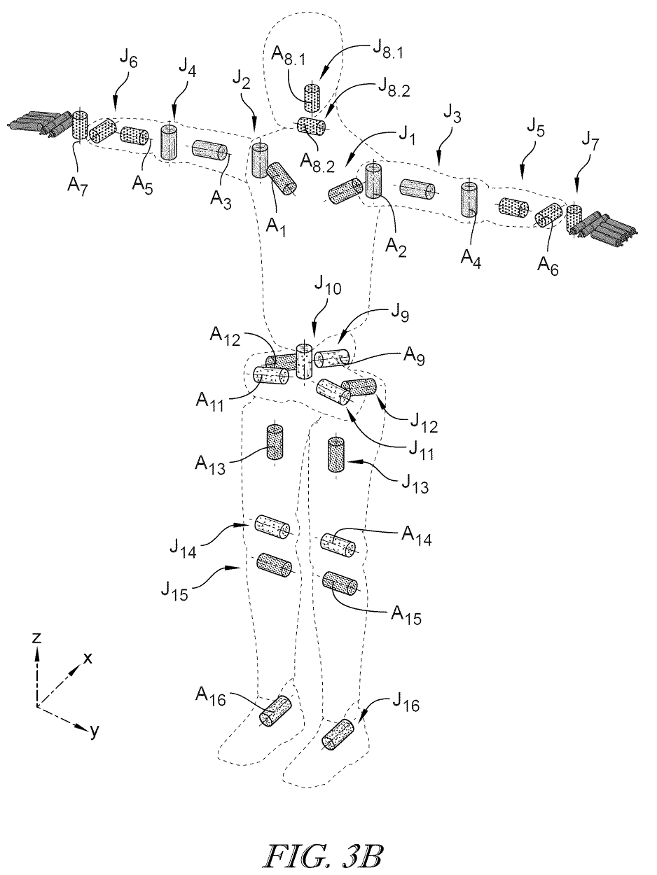

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (Ps) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (Ps) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (Pc) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (PT) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bn): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

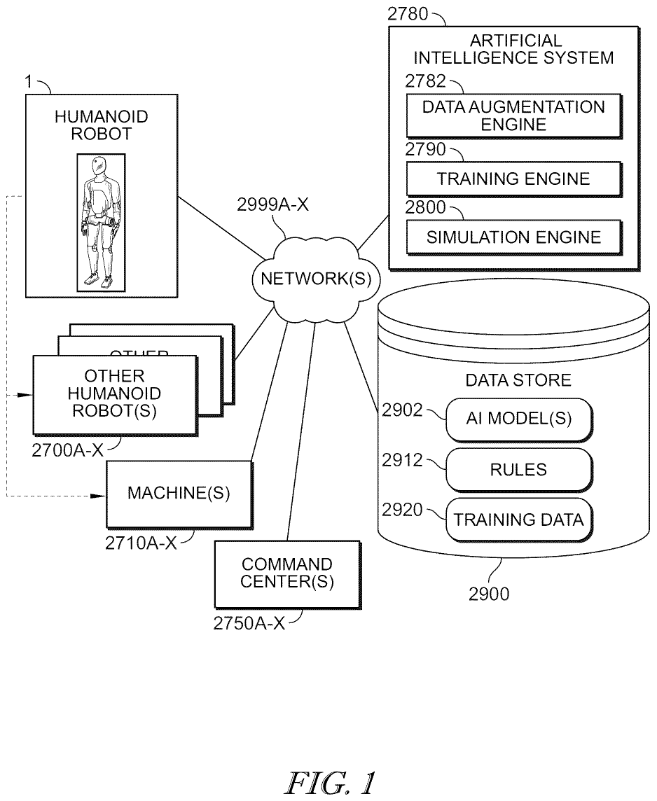

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

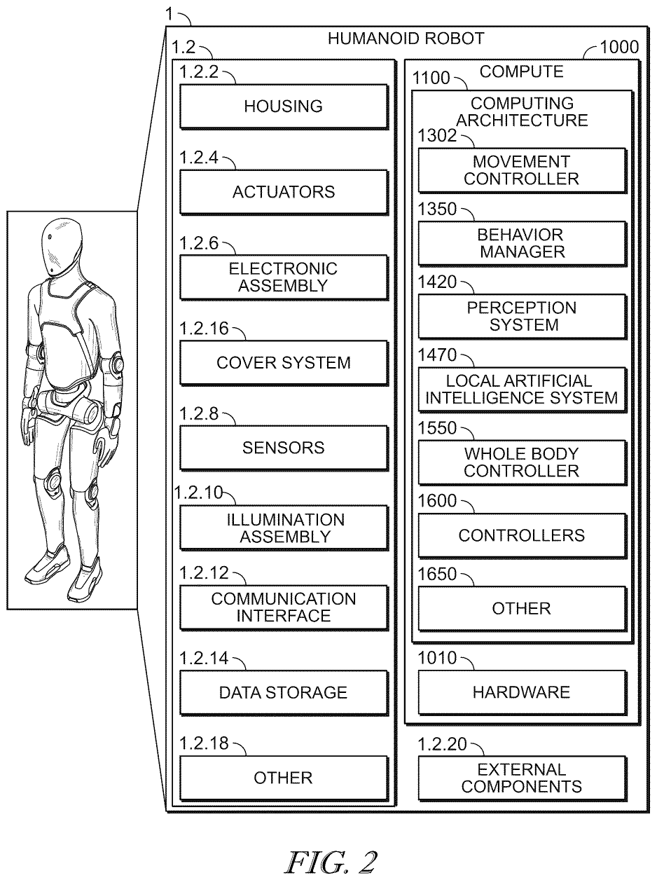

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (Ps) but is asymmetrical about Z-Y and X-Y planes that intersect the head and are parallel to the coronal plane (Pc) and the transverse plane (PT), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (Ps). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 includes various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 2

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, lower humerus | A₄ |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, lower leg pitch, rear kick | A₁₄ |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts.

ii. Sensors

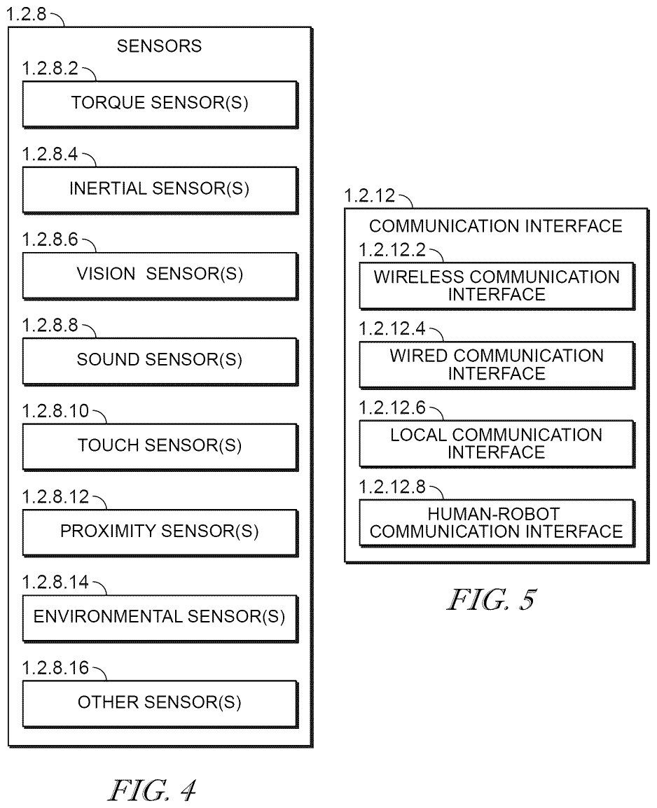

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, vision sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The vision sensors 1.2.8.6 may comprise sensors for capturing vision data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Vision sensors 1.2.8.6 may also include event-based cameras, which report changes in pixel intensity rather than full frames, offering advantages in speed and data efficiency for dynamic scenes. Examples of said vision sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iii. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

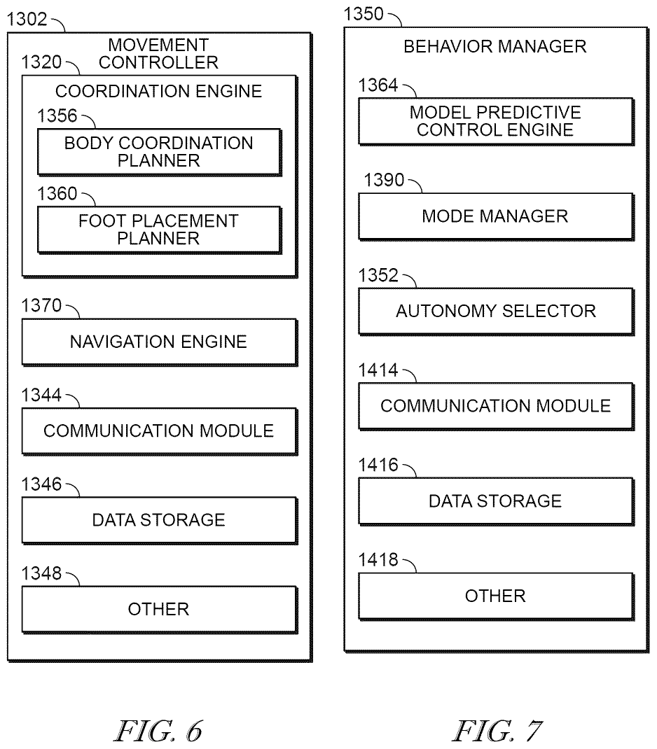

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

2. Behavior Manager

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or position data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

4. Local AI system

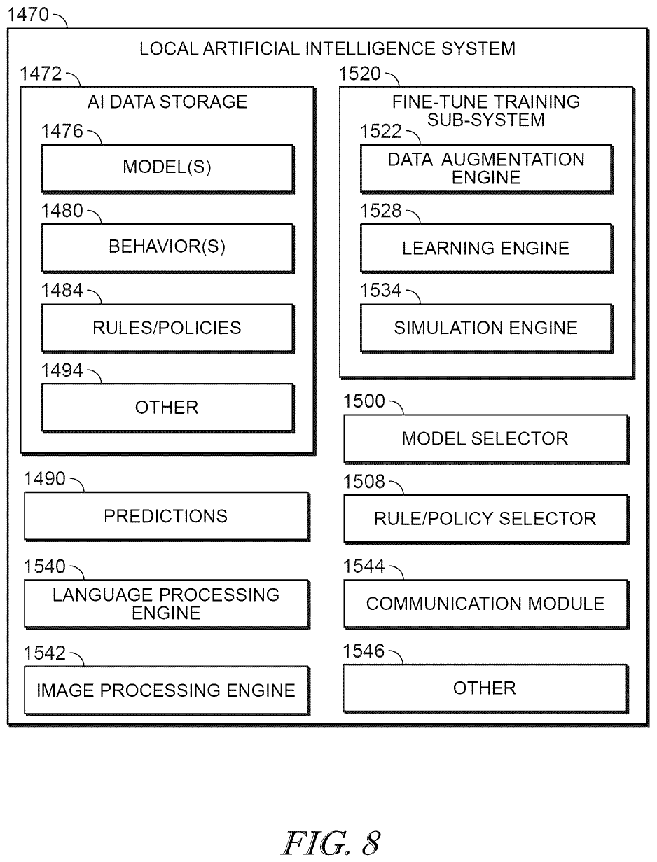

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including vision, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input vision data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and positioning modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

### E. Proprioception System for Humanoid Robot

Humanoid robots are complex electromechanical systems comprising a torso, arms, legs, hands, fingers, feet, and other articulated structures, all of which must be precisely located and oriented within a defined coordinate space for the robot to perform useful work. Without accurate knowledge of where its parts are, a robot cannot reach for an object, walk across a room, or execute any task that depends on coordinated movement. Conventional proprioceptive sensors-such as joint encoders and inertial measurement units (IMUs)—provide partial estimates of a robot's spatial state but are subject to inherent limitations, including sensor drift, measurement noise, occlusion, and limited observability of certain degrees of freedom. Over prolonged operation or under dynamic loading conditions, these limitations compound, degrading the accuracy of spatial state estimation. Accordingly, there exists a need for improved techniques that combine information from a plurality of heterogeneous sensor modalities to enable more robust and accurate estimation of a humanoid robot's spatial state.

The technology disclosed herein addresses this need through a trained machine learning model referred to as a bipedal spatial perception model (BSPM). The BSPM functions as the robot's spatial awareness engine, enabling the robot to perceive its own body, determine where each of its parts is located in three-dimensional space, and use that understanding to precisely control how those parts move. In operation, the BSPM receives image data from one or more cameras mounted on the robot, detects visually distinguishable keypoints on the robot's own components (e.g., feet, end-effectors, or other articulated structures), and computes therefrom an estimate of the position and orientation of those components in three-dimensional space. The BSPM may further output uncertainty metrics alongside its position estimates, enabling the robot's onboard artificial intelligence (AI) system to modulate its control behavior based on the confidence of each spatial state determination. The position estimates produced by the BSPM are delivered to the onboard AI system, which uses them as the foundation for generating motor commands that control the position and movement of the robot's parts and components. This continuous cycle-perceive, determine position, command movement, and repeat-enables the robot to perform tasks with the spatial precision and adaptability that real-world environments demand.

In certain embodiments, the BSPM may operate as the sole source of spatial state information, relying exclusively on camera-derived position data. In other embodiments, a plurality of IMUs—each positioned within a different link or assembly of the robot (e.g., a proximal assembly, a medial assembly, and a distal assembly of an end-effector)—may provide complementary spatial measurements. In yet further embodiments, the BSPM may operate in conjunction with both joint encoders and IMUs in a multi-modal sensor fusion configuration, wherein each sensor modality contributes complementary information to a unified state estimate that exceeds the accuracy achievable by any single sensor in isolation. Regardless of which sensor modalities are employed, the resulting position estimates are delivered to the onboard AI system for real-time motor command generation. The following sections describe how the BSPM is constructed, how it is trained, how it determines the position of robot parts and components during operation, how it delivers that position information to the onboard AI system for real-time control, and how it may be enhanced through sensor fusion techniques that combine camera data with IMU and joint encoder data to produce position estimates that are more accurate and more robust than any single sensor can achieve alone.

a. Generating the Bipedal Spatial Perception Model

The bipedal spatial perception model (BSPM) is the learned model at the center of the robot's spatial awareness system. It can be configured to: (i) detect objects in an image, including visually distinguishable keypoints on the components of the robot 1 (e.g., its feet and end-effectors), and (ii) use the detected keypoints to produce an estimate of the robot's (or an extent thereof) position and orientation in three-dimensional space. These position estimates are the data that the onboard AI system ultimately consumes to control the robot's body. The BSPM may additionally be configured to output per-keypoint confidence scores that quantify the reliability of each individual detection, enabling downstream fusion algorithms to weight the contributions of individual keypoints according to their estimated accuracy. Generating or training the BSPM may include: (i) selecting or obtaining an architecture for the bipedal spatial perception model, (ii) generating a comprehensive training dataset for the BSPM, (iii) training the BSPM, which may be any type of machine learning, deep learning, and/or generative AI-based model, and (iv) preparing the trained BSPM for deployment on a humanoid robot 1. The generation of the BSPM may further include validation of the trained model against held-out test data, compression or quantization of the model for efficient on-device inference, and integration of the model into the robot's software stack with defined input/output interfaces. In some embodiments, the generation of the BSPM may also include an automated hyperparameter search phase in which learning rate, batch size, augmentation probability, and regularization strength are tuned against a validation partition of the training dataset to maximize positioning accuracy while minimizing overfitting. The automated hyperparameter search may employ Bayesian optimization, random search, or grid search techniques to efficiently explore the hyperparameter space and identify parameter configurations that yield favorable convergence and generalization characteristics. Additionally, the hyperparameter search may incorporate early stopping criteria that terminate unpromising trials before completion, conserving computational resources and accelerating the overall model development cycle. In further embodiments, the hyperparameter search may jointly optimize quantization parameters alongside training parameters, ensuring that the model achieves target accuracy at the desired numerical precision for on-device deployment. Each of these steps serves the ultimate goal of producing a model that accurately determines the spatial position of the robot's parts and components, so that the onboard AI system has the reliable position data it needs to control the robot's movements.

i. Selecting the Model Architecture

The first step in generating a BSPM is to select its architecture. Said selection may include selecting: (i) the number of model(s), (ii) the location for training the model(s), (iii) the location for running the model(s), and/or (iv) the identification of how the model(s) will interact with one another. For example, the design may select the use of a single model, that is trained in a remote AI system 2780, is designed to be run on the robot 1 (e.g., at the edge), and the use of one model eliminates the need to determine interactions between models. However, in other embodiments, more than one model (e.g., between 2 and 10) may be used, the models may be split between a remote AI system 2780 and a local AI system 1470, and they may interact with each other using latency vectors or other communication protocols. For example, a lightweight distilled version of the BSPM may be deployed on the robot 1 for low-latency inference during time-sensitive tasks, while a full-capacity version may be maintained on the remote AI system 2780 for batch positioning updates and model retraining. The distilled version may retain the full keypoint detection capability of the parent model while operating with reduced parameter counts (e.g., through structured pruning, channel reduction, or knowledge distillation) that fit within the memory and computational envelope of the robot's onboard processing hardware. The selection between edge-only, cloud-only, and hybrid deployment topologies may be governed by a deployment policy that evaluates network availability, round-trip latency, and the urgency of the positioning task. In some embodiments, the deployment policy may dynamically switch the robot 1 between edge-only and hybrid modes in response to changes in network conditions, such as transient connectivity loss or increased round-trip latency exceeding a configurable threshold. Regardless of where the model runs, its output—the determined position and orientation of the robot's parts and components—is delivered to the onboard AI system so that the robot 1 can control the location and movement of those parts and components in real time.

In addition to selecting the above factors, the designer can also select the type or technology of the model(s), the number of layers contained within each model, how many attention heads are used, the context windows, the number of parameters, the frequency at which the model runs, and/or any other known factor or parameter. For example, the design may select any type, combination, or hybrid of any machine learning model, which includes: generative models (e.g., generative adversarial networks (GANs) (DCGAN, CycleGAN, Pix2Pix, StyleGAN, BigGAN, conditional GANs), variational autoencoders (VAEs) (conditional VAE, VQ-VAE), diffusion models (DDPM, DALL-E 2), autoregressive models (PixelRNN, PixelCNN, Gated PixelCNN)), super-resolution models (SRCNN, SRGAN, ESRGAN, EDSR), image inpainting and restoration models (context encoders, partial convolutions, DeepFill)), vision transformer models (e.g., core vision transformer models (vision transformer (ViT), DeiT (data-efficient image transformers), swin transformer, PVT), or hybrid models (CaiT, CvT, conformer)), attention-based models (e.g., Self-Attention Models (SAGAN, non-local neural networks), or spatial and channel attention (SE-ResNet, CBAM, BAM)), generative models utilizing graphs and geometry (e.g., graph-based models (GCNs, geometric deep learning models), or 3D generative models (3D-GAN, PointNet++, VoxelNet)), multi-modal and cross-modal models (e.g., image captioning models (Show and Tell, Show, Attend and Tell, transformer-based image captioning), visual question answering (VQA) models (MAC Network, Pythia, ViLT), or image-text retrieval models (CLIP, ALIGN, DALL-E)), self-supervised and unsupervised models, neural architecture search (NAS) models, hybrid models integrating CNNs and transformers, multi-task and multi-objective models, optimization and regularization techniques in image models (e.g., data augmentation techniques, regularization techniques, loss functions specific to image tasks), Transfer Learning and Pre-Trained Models for Images (e.g., pre-trained CNNs, pre-trained transformer models), neural radiance fields (NeRF), self-supervised learning models, meta-learning models for images, few-shot and zero-shot learning models, multi-scale and multi-resolution models, neural architecture adaptations, and/or any combination or alteration of the above models. The selection of a particular model architecture or combination of architectures may depend on factors such as the computational budget available on the robot 1, the desired inference latency, the diversity of robot morphologies to be supported, the volume of available training data, and the degree of occlusion tolerance demanded by the anticipated operational environment.

In addition to, or instead of, using any one of the above model(s), the designer may specify that the BSPM includes a feature extractor. The feature extractor is configured to detect features in the input image data such as edges, shapes, motion, and textures, and to transmit data describing these features to other processes within the BSPM that use the features to determine the position of the robot's parts and components. In an embodiment, the feature extractor may be implemented as a feature pyramid network (FPN), which is suitable for multi-scale feature extraction, such as in images where objects can appear at different sizes, scales, and orientations. As is known, an FPN is a feature extractor that generates multiple feature map layers (also known as multi-scale feature maps) in a bottom-up and top-down pathway resembling a pyramid. The bottom-up pathway uses a standard convolutional network, which may be an SE(3)-equivariant backbone to improve viewpoint robustness, to extract features at progressively decreasing spatial resolutions and increasing semantic depth. The top-down pathway then constructs high-resolution layers by upsampling the semantically rich feature maps and merging them with corresponding feature maps from the bottom-up pathway via lateral connections, ensuring that features at every scale have access to both fine-grained detail and high-level semantic information. The resulting feature maps are then output for downstream processing, such as keypoint localization and pose regression, which are the steps where the BSPM converts visual features into the spatial position data that the onboard AI system uses for control. In some embodiments, the feature extractor may further include deformable convolution layers that adapt their receptive fields to the shape of the detected robot components, enabling more accurate feature extraction for non-rigid or articulated structures. In yet further embodiments, the feature extractor may include an attention-gated lateral connection mechanism in which a learned gating function selects the most task-relevant features from each resolution level of the pyramid before propagation to the top-down pathway, reducing the influence of background clutter on the extracted feature representations. In alternative embodiments, the feature extractor may incorporate dilated convolution layers that expand the effective receptive field without increasing the number of parameters, enabling the detection of large-scale spatial patterns while preserving computational efficiency suitable for real-time inference on the robot's onboard processing hardware.

ii. Building the Training Dataset

Once the architecture of the BSPM is selected, the next step is to build the dataset that will teach the model how to detect keypoints and determine the position of the robot's parts and components. Said training dataset may include a core dataset obtained from: (i) visual image data of humanoid robot components collected from the real world, and/or (ii) visual data generated from detailed computer-aided design (CAD) objects along with their associated structural, mechanical, and physical properties. This core dataset comprises visual image data with corresponding ground truth spatial position data that establishes the verified relationship between what the cameras see and where the robot's parts and components actually are. These properties may be modeled using finite element analysis (FEA) or any other type of modeling analysis to simulate how objects might deform under load, thereby providing an additional layer of realism to the training data. If the core dataset includes visual image data collected from the real world, detailed information about the object's physical properties (e.g., size, thickness, border, length, width, etc.) and spatial position (e.g., its 6-DOF pose represented by X, Y, Z, and orientation as a quaternion or Euler angles x′, y′, z′) will be provided with the visual image as ground truth. These physical properties and the spatial position may be provided by a human annotator or by a machine. For example, said physical properties and spatial position may be provided by a machine that moves or rotates a part in space in front of a vision sensor (e.g., camera), wherein the movement of the part is known with high precision because it is controlled by a high-precision robot, allowing for automatic and accurate ground truth data generation. In further embodiments, ground truth data may be provided by an optical motion capture system comprising a plurality of infrared cameras that track retroreflective markers affixed to the robot's components, delivering sub-millimeter positioning accuracy that serves as a high-fidelity reference for supervised training of the BSPM. The use of an automated ground truth generation pipeline reduces the need for manual annotation and enables the collection of large-scale datasets with consistent labeling quality across thousands or millions of training samples. The ground truth data is what teaches the BSPM the correct answer: given this image, the robot's hand is at this specific position and orientation in space.

Additionally or alternatively, the core training dataset may also include: (i) joint measurements for each object if it is articulated, (ii) focal length and other intrinsic measurements associated with the camera, and (iii) robot arm texture data (which can be used to ascertain the distance from the robot 1 to the object). Furthermore, keypoints can be added to or indicated on any data component described above, including CAD images and/or physical robot components. Preferably, the keypoints will be the same keypoints that are utilized during runtime, in a preferred embodiment. This symmetry between the training dataset and the runtime dataset will reduce the errors during runtime use of the model and ensure that the learned feature representations are directly applicable to the deployed inference pipeline, so that the position estimates produced during real-world operation match the quality of those achieved during training. However, it should be understood that the keypoints and robot models used during the training of the BSPM may differ from the robot components analyzed during runtime. In some embodiments, the training dataset may include annotations for keypoint visibility and occlusion state, enabling the BSPM to learn to estimate keypoint positions even when portions of the keypoint are hidden by other robot components or by grasped objects. The training dataset may also include per-keypoint depth annotations derived from stereo disparity or structured-light measurements, providing the BSPM with direct supervision for learning to regress the three-dimensional position of each keypoint from a monocular or stereoscopic image input. In further embodiments, the training dataset may include annotations indicating the degree of partial occlusion for each keypoint, expressed as a continuous visibility fraction ranging from zero (fully occluded) to one (fully visible), enabling the BSPM to learn a graduated confidence response rather than a binary visible-or-occluded classification.

iii. Augmenting the Training Dataset with Synthetic Data

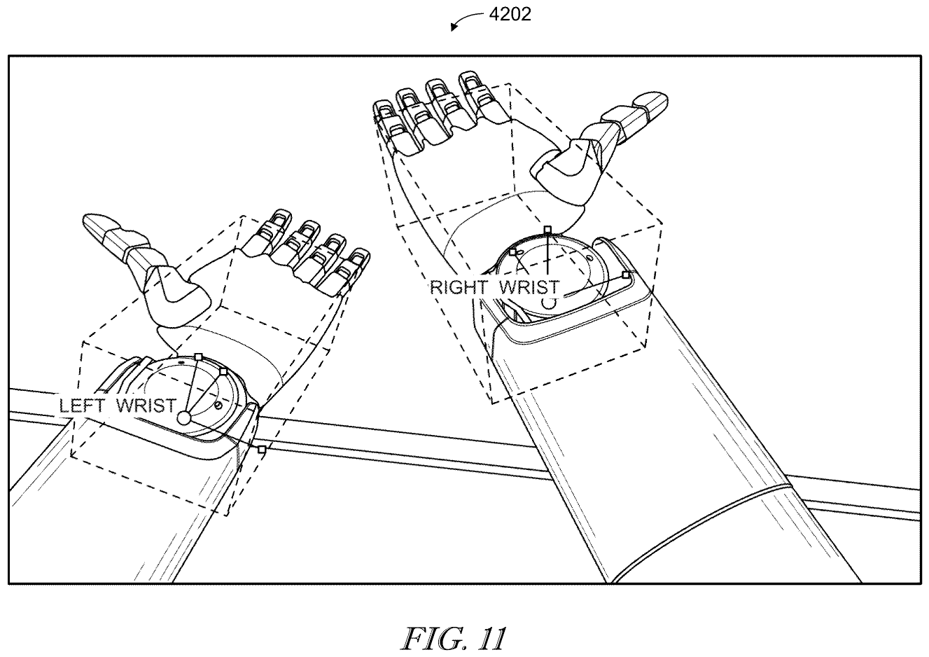

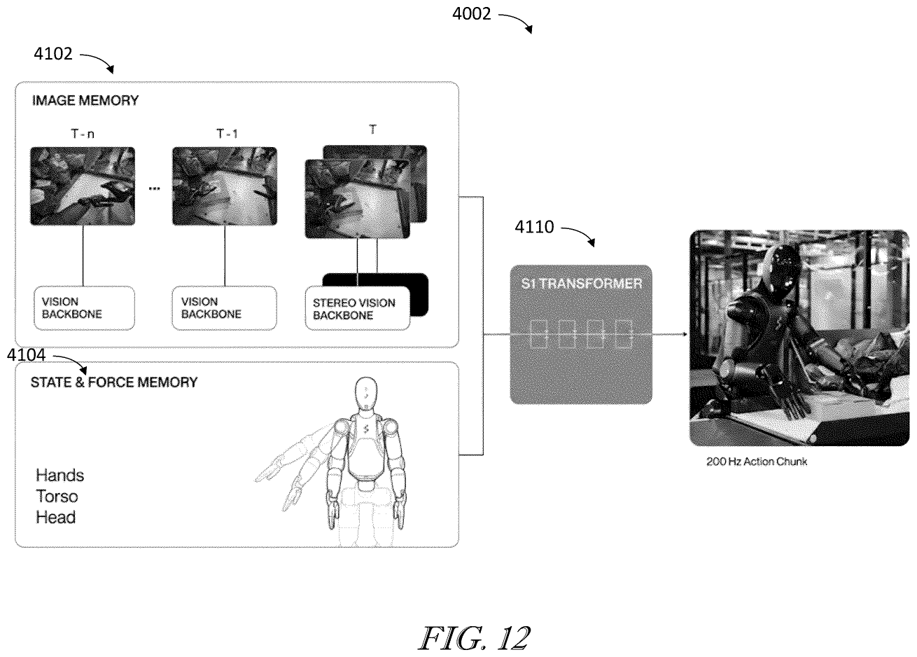

The core training dataset can be augmented by synthetic data, which may include: (i) the original image data from the core dataset, (ii) annotated data related to the core dataset, (iii) a large volume of images from synthetic training data, and/or (iv) the configurable parameters used to generate the synthetic data, wherein said configurable parameters have been modified using a computer program or machine learning model. This augmentation enriches the diversity of examples from which the BSPM learns, improving its ability to determine the position of the robot's parts and components under a wide variety of conditions. For example, in order to generate the three-dimensional (3D) synthetic dataset, a machine learning model may be used to alter or modify the configurable parameters of the core dataset. The configurable parameters of the core dataset include, but are not limited to: (i) type of objects (e.g., sheet metal, cans, stuffed animals, plates, machines, etc.), (ii) characteristics of objects (e.g., types, shapes, sizes, material properties, textures, position, rotation, vectors, etc.), (iii) configurations and poses of the robot 1 as described in the self-supervised preparation process of FIGS. 11-12, (iv) environmental parameters (e.g., lighting direction and intensity, climate conditions, backgrounds, the number and position of light sources), (v) intrinsic camera parameters (e.g., focal length, skew coefficient, optical center, aperture, lens distortions), (vi) an occlusion measure (e.g., a rate by which one or more objects in the scene may be partially occluded by other objects in the scene), (vii) camera position and angles as described in the self-supervised preparation process of FIGS. 11-12, (viii) 2D image data effects like motion blur or noise, (ix) any other known configurable parameter, and/or (x) any combination of the above. The synthetic data generation pipeline may further simulate different wear states of the robot 1 (e.g., scratched or discolored surfaces) and different environmental conditions (e.g., dusty or humid atmospheres) to improve the robustness of the trained model across the robot's operational lifecycle. In some embodiments, the synthetic data generation pipeline may also render multi-robot scenes in which one or more additional humanoid robots appear in the field of view of the robot 1, providing training examples that enable the BSPM to distinguish the keypoints of the robot 1's own body from the visually similar keypoints of other robots operating in the same workspace. In further embodiments, the synthetic data pipeline may simulate sensor degradation effects such as lens fogging, dust accumulation on the camera lens, or progressive reduction in image contrast, training the BSPM to maintain keypoint detection performance even as sensor quality degrades over time between maintenance intervals. The synthetic data generation pipeline may also render scenarios involving varying payload configurations held by the robot 1, such that the BSPM learns to detect keypoints on the robot's hand and arm assemblies even when the visual appearance of these assemblies is partially altered by the presence of grasped objects of different shapes, sizes, and materials.

iv. Training the BSPM

Once the training dataset has reached a first predetermined size threshold, the BSPM can be trained on said training dataset. The goal of training is to teach the BSPM to accurately determine the position of the robot's parts and components from camera images, so that the resulting position data can be fed to the onboard AI system for movement control. Said training of the BSPM can be carried out on any system using the training dataset, including a computing system at a command center, a computing node of a cloud-based AI system 2780, or the computing architecture 1100 of the humanoid robot 1. The training may also be distributed across a plurality of computing nodes using data-parallel or model-parallel training strategies to accelerate convergence and accommodate large dataset sizes. The training of the BSPM can utilize any known method of training a model, and some methods that may be used include: (i) supervised learning techniques (e.g., classification, regression, etc.), (ii) unsupervised learning (e.g., clustering, dimensionality reduction, anomaly detection, etc.), (iii) transfer learning (e.g., by leveraging pre-trained models), (iv) reinforcement learning (e.g., model-free methods, model-based methods), (v) semi-supervised learning (e.g., training with labeled and unlabeled data), (vi) any other known training method, and/or (vii) any combination thereof. The training process may further include curriculum learning, where the BSPM is first trained on simpler examples (e.g., single-joint configurations with clear keypoint visibility) and then on more complex examples (e.g., multi-joint poses with partial occlusion) to facilitate stable convergence. In some embodiments, the curriculum learning schedule may be governed by an automated difficulty estimator that evaluates the loss on each training sample and promotes the sample to the next difficulty tier only after the model achieves a target accuracy on the current tier. The automated difficulty estimator may assign a scalar difficulty score to each training sample based on a combination of the number of visible keypoints, the degree of occlusion, the complexity of the robot's pose, and the diversity of background clutter present in the image. In further embodiments, the curriculum may include a final stage that mixes samples from all difficulty tiers in random proportions, ensuring that the BSPM retains accuracy on simple configurations after being exposed to complex ones.

For example, supervised learning may include training the model on the large dataset consisting of the data contained in the generated training dataset. This approach allows the BSPM to adjust its internal parameters (weights and biases) to minimize a defined loss function, which measures the error between the BSPM outputs (e.g., the location of keypoints, revised kinematic biasing weights, and/or pose of the robot 1) and the known ground truth provided in said training dataset. In essence, the loss function measures how far the BSPM's position estimates are from the true positions, and training adjusts the model to make those estimates as close as possible. This loss function may be a composite of multiple losses, such as Dice loss for segmentation, Intersection over Union (IoU) loss for object detection, and mean squared error or L1 loss for pose vector components, thereby refining its ability to generate accurate and contextually relevant outputs. The composite loss function may also include a keypoint confidence calibration term that penalizes discrepancies between the predicted confidence scores and the actual detection accuracy observed during training, encouraging the BSPM to produce well-calibrated uncertainty estimates. In alternative embodiments, the composite loss function may include a geometric consistency term that penalizes predicted keypoint configurations violating known rigid-body or articulated-body constraints, such as maintaining fixed distances between keypoints on the same rigid link.

In addition to supervised learning, unsupervised learning techniques may be employed to further enhance the BSPM. These techniques primarily focus on identifying patterns and structures within the training dataset itself without explicit labels. For example, the BSPM can be trained using unsupervised methods such as clustering or self-supervised learning, where it learns to: (i) group similar objects together, (ii) identify similar visual features, and/or (iii) predict missing parts of objects or the robot. In some embodiments, a contrastive learning objective may be employed in which the BSPM learns to produce similar feature representations for the same robot component viewed from different angles and dissimilar representations for different components, improving viewpoint invariance. The contrastive learning framework may utilize positive pairs formed by augmented views of the same keypoint region and negative pairs formed by views of different keypoints or background patches, and the training objective may employ a temperature-scaled cross-entropy loss that adjusts the sensitivity of the similarity metric.

Transfer learning can be another method used to fine-tune or train the BSPM. In this approach, the BSPM is first pre-trained on a large, general-purpose dataset and then fine-tuned on the smaller, domain-specific synthetic dataset. This allows the model to leverage the knowledge it has already acquired during pre-training and apply it to more specialized tasks, significantly reducing the amount of data and computational resources for training. In some embodiments, a small set of labeled real images may be used to adapt the detector after hardware changes in a few-shot domain adaptation process, maintaining accuracy while limiting annotation burden. The few-shot domain adaptation may employ prototypical networks or model-agnostic meta-learning (MAML) to enable rapid convergence from only a handful of labeled examples.

Reinforcement learning can also be applied to train or fine-tune the BSPM. In this method, the model is trained to make decisions based on inputs, with the goal of maximizing a reward signal, such as one based on successful task completion. The reward signal may be shaped to include intermediate terms that reward accurate keypoint detection on individual frames, in addition to the terminal reward based on task success, providing a denser learning signal that accelerates convergence. The reward shaping may incorporate auxiliary terms that penalize physically implausible pose estimates, such as joint angles exceeding the mechanical travel limits of the robot's actuators. Finally, semi-supervised learning techniques can be utilized to fine-tune or train the BSPM when a limited amount of labeled training data is available. In a further embodiment, knowledge distillation may be used to compress a large, high-accuracy BSPM into a smaller student model suitable for on-device deployment, preserving the performance of the teacher model while meeting the latency and memory constraints of the robot's onboard computing hardware.

### Active Learning for Efficient Positioning

In some implementations, the learned auto-positioning mechanism can be configured to leverage active learning methodologies to strategically identify and prioritize the most informative positioning samples within the robot's configuration manifold. Rather than executing a rudimentary, uniform range of motion excitement, the BSPM allows the robot 1 to evaluate the intrinsic uncertainty of its existing kinematic model and autonomously select specific poses that are statistically likely to yield the highest information gain. This process can involve the calculation of entropy or predictive variance across the available joint space, subsequently directing the whole body controller to navigate toward high-uncertainty regions where model confidence is minimized. The entropy calculation may be performed using a Monte Carlo dropout technique in which the BSPM is evaluated multiple times with stochastic dropout enabled, and the variance of the resulting pose predictions serves as a proxy for model uncertainty at each candidate configuration. By concentrating acquisition efforts on these informative samples, the system provides a means to significantly diminish the temporal expenditure for a comprehensive positioning cycle while simultaneously ensuring that the resulting biases are robustly optimized across the entire operational manifold of the humanoid platform.

Furthermore, the deployment of active learning can allow the positioning architecture to adapt dynamically to specific task-driven constraints by prioritizing sensory samples that are relevant to frequent or high-consequence motion patterns. In a complex locomotion scenario, the BSPM can be configured to prioritize the dense positioning of ankle, knee, and hip joints at the specific angular velocities and orientations encountered during bipedal gait or stair ascent. This targeted sampling provides a higher localized resolution of positioning in structural regions that are primary to maintaining dynamic balance and postural stability. The BSPM can also allow for the autonomous detection of high-consequence edge cases where the kinematic model is historically likely to produce elevated errors, such as configurations near mechanical singularities or at the absolute limits of joint travel. This selective acquisition strategy provides a technical solution for sustaining high-fidelity accuracy in complex, high-degree-of-freedom humanoid structures while minimizing the total number of physical data collection instances.

v. Multi-Task Learning

The incorporation of multi-task learning techniques can allow the BSPM to perform joint optimization for both kinematic positioning accuracy and functional task performance, thereby ensuring the model is tuned to support the robot's specific operational objectives. By training the neural architecture to minimize a composite loss function comprising re-projection errors in the camera frame and control tracking errors in the manipulation domain, the BSPM can provide a more integrated alignment of the robot's perception and action spaces. The re-projection error measures how accurately the BSPM places keypoints in the image, and the tracking error measures how accurately the onboard AI system's control commands move the robot's parts and components to their intended positions—optimizing both together ensures that the position data the BSPM provides to the onboard AI system directly translates into successful physical movement. For example, during a high-precision manipulation task, the multi-task learning framework can be configured to dynamically adjust finger assembly biases not only to achieve visual consistency but also to maximize the success rate of delicate tactile grasps. The multi-task framework may further include a task-priority weighting schedule in which the relative contribution of each loss term is modulated over the course of training, such that early training epochs emphasize perceptual accuracy and later epochs emphasize task-level success metrics. This joint optimization allows the robot 1 to develop a kinematic model that is inherently biased toward successful task outcomes, effectively accounting for complex dynamic factors such as structural compliance or cable stretch that might be omitted by traditional static positioning protocols.

vi. Meta-Learning for Rapid Adaptation

In further implementations, by employing meta-learning approaches, the BSPM can be configured to rapidly adapt to novel robot configurations, such as the field-replacement of a limb assembly or a significant shift in camera extrinsic parameters, using only a minimal set of demonstration samples. Meta-learning, commonly referred to as “learning to learn,” provides the BSPM with a generalized initialization that can be rapidly specialized to new hardware states through a few-shot fine-tuning process. This capability is particularly beneficial in large-scale deployment environments where multiple humanoid units with slight manufacturing tolerances must be initialized and adjusted in a timely manner. The system allows each individual robot unit to be treated as a discrete learning task, enabling the shared meta-model to identify and compensate for the unique biases of a specific unit within minutes of activation. The meta-model may maintain a library of previously encountered hardware configurations, and upon activation of a new unit, the system may select the closest matching configuration from the library as a warm-start initialization, further reducing the number of fine-tuning samples needed to achieve target positioning accuracy. This rapid structural adaptation provides a scalable solution for maintaining a heterogeneous fleet of humanoid robots, as it eliminates the need for exhaustive, full-scale positioning cycles following every hardware modification or environmental transition. The meta-learning framework may also support incremental library expansion, wherein each newly commissioned robot unit contributes its fine-tuned parameters back to the library upon successful positioning validation, progressively enriching the pool of available warm-start configurations. In some embodiments, the library may organize configurations using a similarity metric based on the hardware revision, serial number, or measured kinematic offsets of each robot unit, facilitating efficient nearest-neighbor lookup during the warm-start initialization process. The system may further log the number of fine-tuning samples consumed during each unit's initialization, enabling fleet-level analytics that identify hardware configurations or environmental conditions that consistently demand more adaptation effort than average.

vii. Online Fine-Tuning During Operation

Additionally, by integrating online fine-tuning strategies, the BSPM can also allow the robot 1 to continuously and incrementally refine its internal positioning parameters during standard operational phases, ensuring the model remains accurate as mechanical conditions fluctuate over time. This process provides a “life-long learning” capability where the BSPM monitors the statistical consistency between visual, inertial, and encoder data streams in real-time and applies small, non-disruptive updates to the joint bias offsets. In practical terms, this means the position data the BSPM provides to the onboard AI system stays accurate even as the robot's body changes through wear and environmental exposure. The online refinement can be configured to utilize stochastic gradient descent mechanisms on the fly, leveraging the natural, unconstrained motions of the robot 1 as a continuous and rich stream of positioning data. This ensures the robot 1 can adapt autonomously to slow-moving mechanical trends, such as the gradual loosening of a cable-driven transmission, the settling of structural fasteners, or the expansion of metal frames due to varying ambient temperatures and internal heat generation. The online fine-tuning process may also maintain a buffer of recent observations and perform periodic batch updates to ensure that the cumulative effect of many small updates does not lead to parameter drift beyond acceptable bounds. In some embodiments, the buffer may implement a first-in-first-out eviction policy with a configurable retention window, and the system may trigger a batch update when the buffer reaches a predefined occupancy threshold or when a timer interval elapses, whichever occurs first. The buffer capacity may be configurable based on available memory, with typical sizes ranging from several hundred to several thousand observation samples. In alternative embodiments, the buffer may implement a priority-based eviction policy that retains observations with higher information content, as measured by the magnitude of the prediction residual at the time of observation, thereby ensuring that the most informative samples are preserved for batch updates while less informative samples are evicted first.

viii. Reinforcement Learning-Based Positioning

In some further implementations, reinforcement learning-based positioning can be adopted to allow the BSPM to dynamically adjust kinematic parameters in real-time based on the direct performance feedback received from the physical environment. In this reinforcement framework, the robot's measured task success—such as the dynamic stability of a gait on slippery terrain or the sub-millimeter accuracy of a pick-and-place operation—serves as a primary reward signal that guides the iterative adjustment of kinematic biases. The whole body controller can be configured to explore infinitesimal variations in the joint offsets and observe the resulting impact on the global cost function, allowing the system to converge autonomously on an optimal set of parameters that maximize operational efficiency. This approach provides a robust technical mechanism for managing complex, non-linear disturbances where a direct analytical correction is not computationally feasible. For manipulation, this can involve the fine-tuning of end-effector offsets during a recurring task, allowing the robot 1 to achieve superior precision by learning the optimal bias through repeated, reinforced interaction with the workspace. The reinforcement learning agent may employ a soft actor-critic or proximal policy optimization algorithm with a clipped exploration range that constrains the magnitude of per-step bias adjustments, preventing the agent from proposing large parameter changes that could compromise the stability of the robot 1 during exploration. In alternative embodiments, the reinforcement learning agent may employ a trust-region method that maintains an explicit constraint on the Kullback-Leibler divergence between successive policies, providing a formal guarantee that parameter updates remain within a safe neighborhood of the current operating point. The exploration range may be annealed over time, beginning with a wider range during initial adaptation and progressively narrowing as the kinematic parameters converge toward their optimal values.

ix. Federated Learning Across a Fleet

The BSPM can also be trained utilizing federated learning techniques, which allow for the secure sharing of high-level positioning knowledge across a plurality of deployed humanoid units without the need for direct transmission of raw, sensitive sensor data. In a decentralized fleet of robots, each individual unit can be configured to perform localized positioning and model refinement based on its unique operational experiences and specific environmental interactions. The resulting model gradients or compressed parameter updates can then be transmitted to a centralized server, where they are statistically aggregated to improve a comprehensive “global” kinematic model that is subsequently redistributed to all units in the field. Because the BSPM's purpose is to determine the position of the robot's parts and components for the onboard AI system, federated learning effectively means that every robot in the fleet benefits from the collective spatial awareness experience of all other robots. The federated aggregation may use techniques such as weighted averaging, where each robot's contribution is weighted by the quantity and quality of its positioning data, or robust aggregation methods that filter out contributions from malfunctioning units. In some embodiments, the federated aggregation may employ a differential privacy mechanism that adds calibrated noise to the transmitted gradients, ensuring that the raw sensor data of any individual robot cannot be reconstructed from the shared model updates. The calibrated noise may be parameterized by a privacy budget that is configurable by a fleet administrator, enabling the system to balance the trade-off between model convergence rate and data protection stringency according to organizational policy. In further embodiments, the federated learning framework may support asynchronous gradient submission, wherein each robot transmits its model updates upon completion of a local training round without waiting for other robots in the fleet, reducing idle time and enabling efficient aggregation across robots with heterogeneous computational capabilities.

This collaborative learning architecture allows for the rapid identification of systemic mechanical issues or recurring sensor drift patterns across a diverse set of operating conditions and hardware revisions. For instance, if several robots in a fleet encounter a specific joint bias drift due to a particular high-load task profile, the federated learning system can be configured to propagate a preemptive corrective model to all other units performing similar tasks. This shared fleet knowledge provides the entire robotic population with the ability to anticipate and correct for positioning errors before they manifest as failures in task performance. The architecture can also allow for the specialized training of models optimized for different domains—such as a “warehouse-optimized model” or a “construction-site model”—by aggregating data from robots working in similar environments, ensuring that each unit is equipped with the most relevant kinematic priors for its specific operational role. In a further embodiment, the centralized server may maintain a model registry that tracks the version, training provenance, and performance metrics of each domain-specific model, and the system may assign the most appropriate model to a newly deployed robot 1 based on a profile that describes its intended operational environment.

x. Physics-Based Modeling

In some further implementations, physics-based modeling can be incorporated to allow the BSPM to significantly enhance the accuracy and reliability of pose estimates in edge cases where sensor data may be excessively noisy or temporarily incomplete due to occlusion. By embedding a differentiable kinematic layer directly into the neural network architecture, the system can be configured to enforce hard physical constraints, such as joint travel limits, link non-penetration conditions, and center-of-mass stability constraints, during the pose estimation process. These constraints ensure that the position data the BSPM delivers to the onboard AI system always describes a physically possible configuration of the robot's body. This prevents the generation of “non-physical” or “phantom” poses that might otherwise result from visual occlusions or sensor anomalies, because the onboard AI system could not safely generate motor commands based on a physically impossible position estimate. These physics-based priors provide a regularizing effect that improves the convergence stability of the pose optimization, particularly during high-dynamic motions where high inertial forces may temporarily skew the readings of on-board accelerometers. In some embodiments, the differentiable kinematic layer may also model the robot's mass distribution and inertial properties, enabling the BSPM to predict and compensate for load-dependent deflections of the kinematic structure. The differentiable kinematic layer may further incorporate a forward dynamics module that predicts the expected joint accelerations given the current motor commands, and the predicted accelerations may be compared against the IMU-measured accelerations to detect anomalous loading conditions such as unexpected collisions or payload shifts. In alternative embodiments, the forward dynamics module may be implemented as a learned residual dynamics model that captures unmodeled effects such as joint friction, cable routing compliance, and actuator saturation, providing a more accurate prediction of the expected acceleration than a purely analytical model. The discrepancy between the predicted and measured accelerations may be logged and trended over time, enabling the system to detect gradual degradation of actuator performance or progressive loosening of structural fasteners.

xi. Adversarial Verification

Furthermore, the development of an adversarial positioning approach may allow for a secondary “critic” model to monitor, detect, and correct potential errors in the primary positioning process. In this adversarial configuration, the primary BSPM generates a pose estimate and proposed positioning update, while the secondary adversarial model is trained to distinguish between “authentic” poses—those consistent with established physical, structural, and historical norms—and “erroneous” poses that deviate from those norms. If the adversarial critic identifies a high probability of error in the primary model's proposed positioning, it can trigger a corrective feedback loop or initiate a more rigorous validation check using the constraint structure. This adversarial relationship provides a robust “check and balance” system that enhances the overall operational reliability of the position estimates delivered to the onboard AI system. For locomotion, this can prevent a faulty positioning update from compromising the robot's balance, as the adversarial model can be configured to flag and reject any update that significantly increases the predicted uncertainty of the center-of-mass trajectory. The adversarial critic may also maintain a statistical record of rejected updates, which can be analyzed to identify recurring failure modes in the primary BSPM and inform future retraining efforts. In some embodiments, the adversarial critic may be trained using a dataset of deliberately corrupted pose estimates generated by injecting known error patterns into ground truth data, enabling the critic to develop sensitivity to a broad taxonomy of positioning failure modes including joint slip, sensor dropout, and kinematic chain discontinuities. In further embodiments, the adversarial critic may operate at multiple spatial granularities, maintaining separate detection modules for global body-level pose errors, limb-level pose errors, and joint-level angular errors, enabling the system to isolate the specific source of a detected positioning anomaly with fine-grained spatial precision.

xii. Validating the Trained Model

The accuracy of the trained BSPM can be determined by comparing the BSPM outputs (e.g., the location of keypoints, revised kinematic biasing weights, and/or pose of the robot 1) to the actual, ground truth parameters of a test dataset. If the accuracy of the comparison between the BSPM outputs and the ground truth parameters is less than a predetermined value (e.g., 90%, 95%, 97%, 99.5%), further training or fine-tuning of the BSPM may be performed. This may involve: (i) generating a training dataset that has a second predetermined size threshold, wherein the second predetermined size threshold is larger than the first predetermined size threshold, and then further training the BSPM using any known training method, (ii) using additional or different training methods on the same training dataset, (iii) generating a new training dataset that includes specific target domain data to bolster specific inaccuracies of the BSPM (e.g., specific target domain data may focus on identification of a specific keypoint located on an edge of a foot, if the BSPM consistently failed to properly identify the keypoint), or (iv) any other known method of improving the accuracy of the BSPM. The further training of the BSPM is completed after its accuracy of the comparison between the BSPM outputs and the ground truth parameters is greater than a predetermined value (e.g., 90%, 95%, 97%, 99.5%). In some embodiments, the accuracy evaluation may also include per-keypoint and per-joint analysis, in which the system identifies the subset of keypoints or joints that contribute the greatest share of the aggregate error and generates targeted training data that over-represents those specific regions of the robot's body. The per-keypoint analysis may further generate a spatial error map that visualizes the distribution of estimation errors across the robot's body, enabling engineers to identify systematic weaknesses in the BSPM's detection capability and to prioritize corrective actions accordingly. In further embodiments, the accuracy evaluation may include an assessment of the BSPM's performance under distribution shift conditions, wherein the test dataset includes images captured under lighting, background, and camera configurations not represented in the training dataset, to verify that the model generalizes beyond its training distribution. Validation is the final checkpoint before the BSPM is deployed on the robot 1, ensuring that the position data it will deliver to the onboard AI system meets the accuracy thresholds that safe and effective operation demands.

b. Use of the BSPM: Determining Position and Feeding It Back for Control

With the BSPM trained and validated, it is deployed on the robot 1, where it serves an overarching purpose: to determine the position and orientation of the robot's parts and components in space and to provide that position data to the onboard AI system so the robot 1 can control the location and movement of those parts and components. The parts and components whose positions are determined by the BSPM include the torso 16, limbs such as arms and legs, joints such as elbows, wrists, knees, and ankles, end effectors including fingers, thumbs, and parts thereof, and feet. The BSPM may also determine the position of the head 10.1, the neck joint coupling the head 10.1 to the torso 16, and the shoulder and hip joints that couple the limbs to the torso 16, providing a complete spatial description of the robot 1 from head to foot. The advantages of determining and controlling the position of the robot's parts and components through camera-based perception in real time are numerous and extend across cost, size, precision, and robustness dimensions. For example, camera-based perception allows for the removal of additional sensors, which reduces cost and shrinks the physical size of parts and components while also eliminating potential points of mechanical failure. Additionally, this method provides high spatial resolution, which enables the performance of intricate manipulation tasks such as threading a needle or assembling small mechanical fasteners. Furthermore, this method is more robust to environmental noise, such as strong electromagnetic interference (EMI) that may be present in a factory environment. Camera-based positioning also provides the advantage of remote observability, wherein the position of a component can be determined even when no sensor is physically mounted on or near the component, expanding the set of robot configurations for which accurate spatial state estimation is achievable. Camera-based perception further provides the advantage of scalable coverage, wherein a single camera may observe and determine the positions of multiple components within its field of view, thereby reducing the total sensor count relative to an approach that requires a dedicated sensor at each component.

i. How the BSPM Processes Image Data

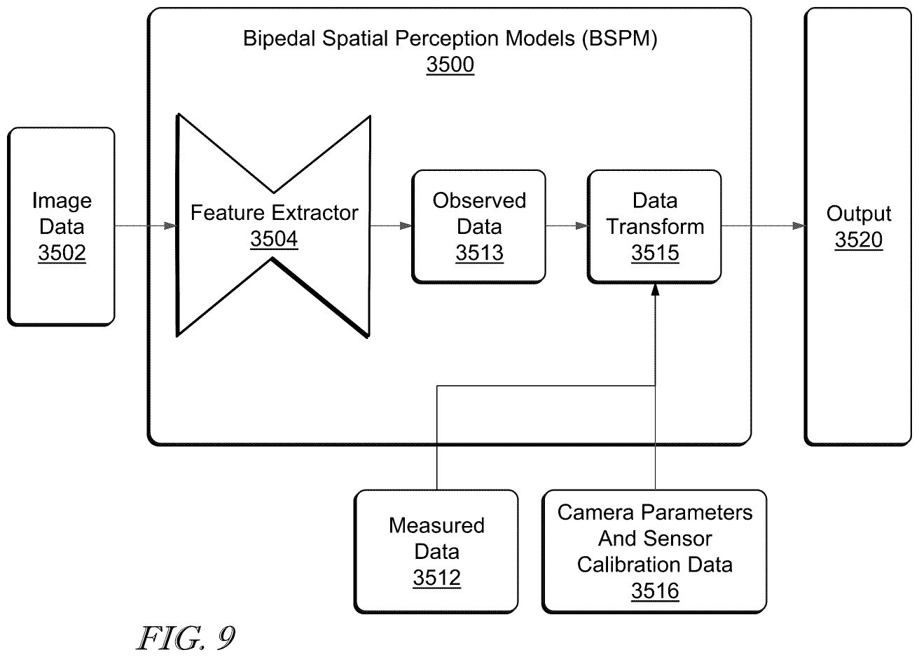

As shown in FIGS. 9-12, the robot 1 uses the deployed BSPM to determine the positions of its parts and components in real time using camera/image data. Specifically and as shown in FIG. 9, the BSPM receives image data 3502 obtained from vision sensors 1.2.8.6. The vision sensors 1.2.8.6 include cameras mounted in the head 10.1 of the humanoid robot 1, such as cameras 108.2.2 and 108.2.4, as well as cameras mounted on or near the robot's hands, such as cameras 108.2.6 and 108.2.8. In some embodiments, the vision sensors 1.2.8.6 may further include cameras mounted on the torso 16, on the upper arms, or on the lower legs of the robot 1, providing additional vantage points that reduce the occurrence of self-occlusion during complex manipulation and locomotion tasks. The BSPM processes the image data 3502 to produce observed data 3513, which represents the determined positions of the robot's parts and components as seen by the cameras. The observed data 3513, together with kinematic model data 3512 and optionally camera parameter and sensor data 3516, is used by the BSPM to generate outputs 3520. The camera parameter and sensor data 3516 may include intrinsic camera parameters such as focal length, principal point, and lens distortion coefficients, as well as extrinsic parameters describing the pose of each camera relative to the robot's base frame, and these parameters may be updated online through the self-calibration processes described herein. The outputs 3520 comprise the determined locations of a plurality of keypoints positioned on the end effectors and feet. These determined positions are provided to the onboard AI system of the robot 1, which uses them to understand the spatial state of the robot's body and to generate control commands for positioning and moving the robot's parts and components.

ii. Keypoint Detection

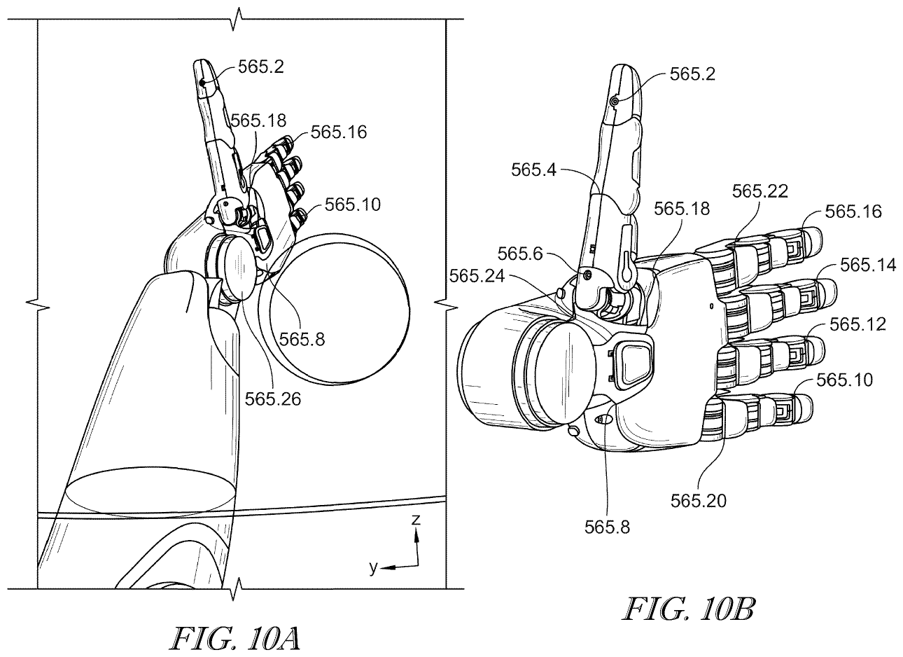

The BSPM determines the positions of the robot's parts and components by detecting and localizing keypoints. Keypoints are visually distinguishable points or features on the components of the robot 1, or around joints such as wrists, ankles, elbows, and knees, that the BSPM can reliably detect and identify from camera images. To illustrate, a keypoint might be the center of a screw head on the robot's wrist, a corner of a rectangular cutout on a finger assembly, or the endpoint of a groove on a foot panel—any visually distinctive feature that the BSPM has been trained to recognize. Examples of said keypoints are shown in FIGS. 10A and 10B, where keypoints 565.2-565.26 are depicted. The external covers may be removed from the robot 1 or may remain on the robot 1 during operation, and the BSPM may be trained to detect keypoints under both covered and uncovered configurations. In some embodiments, the BSPM may maintain distinct keypoint detection models or distinct weight sets within a single model for the covered and uncovered configurations, and the system may select the appropriate model or weight set based on a configuration flag set by an operator or based on an automatic cover-detection classifier that determines whether the covers are present from the image data.

In some embodiments, micro-scale UV/IR patterns, such as micro-printed dot grids, are applied to surfaces of the robot 1 as micro-fiducials that are detectable by the BSPM but unobtrusive to human users, enabling continuous position determination without visible markers. The micro-fiducials may be printed using UV-fluorescent ink that is invisible under standard ambient lighting conditions but becomes detectable when illuminated by a UV LED integrated into the camera assembly. The micro-fiducials may be arranged in a spatially encoded pattern in which each fiducial's position within the pattern encodes a unique identifier, enabling the BSPM to determine which specific surface region of the robot 1 is being observed from a single fiducial detection. In other embodiments, the BSPM uses markerless body-texture cues, where the model learns self-appearance descriptors that persist across panel swaps or repainting to support tag-free detection of body parts. In a further embodiment, keypoints are defined at the intersection of distinct surface features, such as where a seam line meets a fastener head, providing keypoints that are robust to partial occlusion because the position of the keypoint can be inferred from whichever feature remains visible. In an additional embodiment, the keypoints include virtual keypoints that do not correspond to a physical feature on the robot surface but are instead defined at a computed geometric center of a group of physical features, and the BSPM infers the position of the virtual keypoint from the detected positions of the surrounding physical features using a learned geometric interpolation function. The learned geometric interpolation function may be trained to account for non-rigid deformations of the robot's surface panels under load, such that the virtual keypoint position is adjusted based on the observed displacement of the surrounding physical features relative to their nominal positions.

From the detected keypoints, the BSPM calculates the 2D or 3D positions of the observed keypoints in the frame of reference of the camera for each captured image. These calculated positions are the spatial data that the onboard AI system will consume to control the robot's movement. When calculating 3D positions from 2D image observations, the BSPM may employ triangulation using keypoint detections from two or more cameras with known extrinsic parameters, or the BSPM may infer depth from a single camera view using learned monocular depth estimation as described herein. The BSPM may also output a confidence score for each detected keypoint, and keypoints with confidence scores below a threshold may be excluded from the position output to prevent noisy detections from degrading the accuracy of the determined positions. The confidence score may be derived from the softmax output of the BSPM's detection head, and the threshold may be set to a value between 0.5 and 0.99, which may be configurable by an operator or determined by a learned threshold selection policy. In further embodiments, the confidence threshold may be dynamically adjusted based on the current operational context, such that a lower threshold is applied when fewer keypoints are visible (e.g., due to occlusion) and a higher threshold is enforced when many keypoints are simultaneously visible, balancing detection coverage against detection reliability. In yet further embodiments, the confidence score may incorporate a temporal consistency component that increases the confidence of a keypoint detection when the detected position is consistent with the position predicted from the previous frame's detection and the estimated velocity of the component, and decreases the confidence when the detected position deviates from the predicted position by more than a configurable spatial tolerance.

To improve the quality of the image data from which the BSPM determines positions, image capture may be triggered during low-motion windows inferred from IMU data, or images may be de-blurred using inertial priors, to improve keypoint signal-to-noise. For example, image capture may be triggered when IMU-derived angular velocity and linear acceleration both fall below respective thresholds, and captured images may be deblurred using a point-spread function parameterized by IMU-measured motion during the exposure time of the camera. Camera exposures can be synchronized to IMU timestamps to reduce rolling-shutter distortion, and the synchronization may be achieved using a hardware trigger signal or a software timestamp alignment protocol. In a further embodiment, the image capture process may employ exposure bracketing, where multiple images at different exposure levels are captured to ensure that keypoints remain visible under varying lighting conditions. The exposure bracketing may capture a set of three or more images spanning a range of exposure values centered on a nominal exposure determined by an auto-exposure algorithm, and the BSPM may select the image with the best keypoint visibility or may fuse keypoint detections across the bracketed images using confidence-weighted averaging. In yet another embodiment, the system may capture images at two or more distinct focal lengths or focus distances to maximize the sharpness of keypoints located at different depths within the camera's field of view. In a further embodiment, the camera may employ a variable-aperture mechanism that adjusts the depth of field based on the range of depths at which keypoints are expected to appear, as estimated from the previous frame's position data, thereby balancing sharpness across the depth range against the available illumination.

iii. Pose Estimation of Parts and Components

Building upon the keypoint positions described above, the BSPM determines the full pose—- meaning the position and orientation—of the robot's parts and components. While individual keypoints provide discrete spatial measurements, a full pose provides the onboard AI system with a complete six-degree-of-freedom (6-DoF) description of where a given part is located and in which direction it is facing. This full pose description is the information the onboard AI system uses to generate the motor commands that move a given part from its current spatial state to its intended destination. In the absence of such full pose information, the onboard AI system would be constrained to operate on incomplete spatial representations that lack rotational context, thereby degrading the precision of downstream control actions. The determination of full pose thus serves as the bridge between passive spatial observation and active motor command generation, and it enables the onboard AI system to plan and execute movements that account for both the translational displacement and the angular reorientation of each tracked part or component.

The BSPM may be trained to recognize the overall shape and appearance of the limbs of the robot 1 and to regress their full three-dimensional pose from a single image captured by one or more onboard cameras. This holistic pose estimation approach is robust to partial occlusion because it leverages the global shape, contour, and appearance of the limb rather than relying on the visibility of individual discrete keypoints. For example, if a portion of a forearm is occluded by an object being manipulated, the holistic estimator may still infer the forearm's pose from the visible shoulder, upper arm, and elbow geometry. In some embodiments, the BSPM estimates the pose of a part or component using keypoint-based estimation, holistic pose-based estimation, or a weighted combination of both, where the relative weighting between the two approaches may be dynamically adjusted based on the degree of occlusion detected in the current image frame. In a combined approach, the holistic pose estimation may provide an initial coarse position determination that establishes an approximate spatial envelope for the part, and the keypoint-based method may subsequently refine the determination to sub-millimeter accuracy by localizing individual anatomical or structural landmarks within that envelope. In some embodiments, the degree of occlusion may be estimated by comparing the number of detected keypoints against the expected number of keypoints for the given part when fully visible, and the ratio of detected to expected keypoints may be used to compute the weighting factor that governs the relative contribution of the holistic and keypoint-based estimates.

The BSPM may express the determined positions and orientations of the robot's parts and components using a delta SE(3) pose representation. In this representation, a pose update is expressed as a six-dimensional vector in the Lie algebra se(3), comprising a three-dimensional translational component in [symbol] ³ and a three-dimensional rotational component parameterized in the Lie algebra so(3) of the rotation group. This representation avoids the gimbal lock singularities associated with Euler angle representations and provides a smooth, continuously differentiable gradient landscape that facilitates stable convergence during the learning process. The SE(3) tangent-space parameterization further ensures that small perturbations in the six-dimensional vector correspond to geometrically meaningful small motions of the rigid body, which preserves the physical interpretability of the learned pose updates. The onboard AI system receives the SE(3) pose of each tracked part or component and uses it to compute the spatial transformations that define the motor commands for moving the part or component from its current pose to a desired target pose. The SE(3) representation also facilitates the composition of pose updates along a kinematic chain, wherein the pose of a distal component (e.g., a fingertip) is computed as the product of the SE(3) transformations at each intervening joint, and the gradient of the distal pose with respect to each joint parameter is obtained through the chain rule applied to the Lie group product.

In alternative embodiments, the BSPM may express the orientation component of the pose using a rotation matrix representation belonging to the special orthogonal group SO(3) or a unit quaternion representation belonging to the three-sphere S³. The rotation matrix representation offers the advantage of a unique, non-singular mapping at the cost of a nine-element parameterization with six implicit orthogonality constraints, while the unit quaternion representation provides a compact four-element encoding that avoids gimbal lock but introduces a double-cover ambiguity in which two antipodal quaternions represent the same physical rotation. The choice among SE(3) tangent vectors, rotation matrices, and unit quaternions may be governed by the downstream control algorithm's preference for a particular rotation parameterization, the computational budget available for enforcing normalization or orthogonality constraints, and the sensitivity of the loss function to the topology of the chosen rotation space. In further embodiments, the BSPM may employ a six-dimensional continuous rotation representation that maps smoothly from [symbol] ⁶ to SO(3), thereby combining the continuity benefits of the Lie algebra parameterization with the direct interpretability of a rotation matrix. The system may also maintain multiple concurrent rotation representations internally and select the most appropriate one for each downstream consumer based on a configuration parameter or a learned selection policy. In yet further embodiments, the BSPM may convert between rotation representations on demand, maintaining a canonical internal representation (e.g., unit quaternion) and providing accessor functions that return the orientation in the representation requested by the downstream consumer, thereby decoupling the internal state representation from the interface contract with each consuming module.

In addition to point estimates of the pose, the BSPM may output an uncertainty estimate associated with each estimated pose. The uncertainty estimate may take the form of a 6×6 covariance matrix defined over the SE(3) tangent space, capturing the coupled translational and rotational uncertainty in a single unified representation. Alternatively or additionally, the BSPM may generate a pose uncertainty ellipsoid that provides a geometric visualization of the spatial directions in which the estimate is least constrained, with the principal axes of the ellipsoid aligned to the eigenvectors of the covariance matrix and scaled by the corresponding eigenvalues. The onboard AI system may use this uncertainty information to modulate the aggressiveness of its control actions—applying more conservative, lower-velocity movement commands when the position estimate is less certain and more decisive, higher-velocity commands when the estimate is highly certain. In some embodiments, the uncertainty estimate may also be propagated through the kinematic chain, such that the uncertainty of a distal component (e.g., an end effector) reflects the accumulated uncertainties of all proximal joints and links, providing the onboard AI system with a comprehensive measure of end-effector positional confidence. In further embodiments, the onboard AI system may use the uncertainty estimate to select between alternative motion plans, choosing a plan that routes the end effector through regions of the workspace in which the BSPM has demonstrated lower estimation uncertainty, even if the chosen plan involves a longer path, thereby trading path length for estimation confidence and overall task reliability.

The BSPM may also provide the first and second time derivatives of the estimated pose (i.e., the spatial velocity and spatial acceleration, respectively) when temporal sequences of images are processed. The spatial velocity may be represented as a twist vector in SE(3), encoding both the linear velocity and angular velocity of the tracked part in a unified six-dimensional format. The spatial acceleration may similarly be represented as a six-dimensional vector capturing the rate of change of the twist. These derivative quantities enable the onboard AI system to implement predictive control strategies that anticipate the future spatial state of the robot's components, rather than reacting solely to the most recently observed state. In some embodiments, the BSPM may compute these derivatives using finite differences between consecutive pose estimates, using a learned temporal convolutional network that operates over a sliding window of pose estimates, or using a recurrent neural network architecture (e.g., a long short-term memory network or a gated recurrent unit) that maintains a hidden state encoding the recent motion history of each tracked component. In further embodiments, the BSPM may compute higher-order derivatives (e.g., the jerk, which is the third time derivative of position) and may provide these higher-order derivatives to the onboard AI system to enable motion planning algorithms that constrain not only position, velocity, and acceleration but also jerk, producing smoother and more mechanically gentle trajectories that reduce wear on the robot's actuators and transmission components.

An example of the pose estimation is shown in FIG. 11, which depicts an image of an end effector of the robot 1. Overlaid on the end effector is a three-dimensional bounding box and a representation of the coordinate frame of the wrist, corresponding to the estimated 6-DoF pose (position and orientation) of the hand. The coordinate frame representation may comprise three mutually orthogonal axis indicators (e.g., color-coded arrows) that visually convey the orientation of the x-axis, y-axis, and z-axis of the hand's local reference frame relative to a global or camera-centric reference frame. This determined pose is provided to the onboard AI system, which uses it to ascertain the precise location and orientation of the hand in three-dimensional space and to generate motor commands that position and orient the hand to accomplish a desired task. In some embodiments, the BSPM may additionally estimate the articulation state of the end effector itself (e.g., the degree of finger flexion, the aperture of a parallel-jaw gripper, or the angular displacement of individual finger segments), providing the onboard AI system with a complete kinematic description of both the wrist pose and the end-effector configuration. In further embodiments, the BSPM may estimate the contact state of the end effector, determining whether each finger or gripper surface is in contact with an object and, if so, the approximate contact location and contact normal direction, enabling the onboard AI system to plan subsequent manipulation actions with knowledge of the current grasp configuration.

iv. Real-Time Position Determination During Operation

The BSPM continuously determines the positions and poses of the robot's parts and components in the background while the robot 1 is performing tasks. Rather than determining positions only during a dedicated calibration or initialization routine, the BSPM observes the robot's components as they move during normal operation and provides the onboard AI system with a continuously updated spatial state of each observed component. This continuous position determination establishes and sustains the closed-loop control cycle described throughout this disclosure: the BSPM determines a position, delivers that position data to the onboard AI system, the onboard AI system generates motor commands based on that position data, the robot's parts move in response to those motor commands, and the BSPM determines the new position in the next cycle. The onboard AI system uses this continuously updated spatial state as a feedback signal for closed-loop control, allowing the robot 1 to adjust the trajectory, velocity, and orientation of its parts and components during task execution without interrupting the ongoing task. This continuous position determination using camera and image data may allow the robot 1 to omit certain conventional sensors (e.g., torque sensors, rotary encoders, or strain gauges), thereby reducing the overall cost of the robot, reducing the weight and mechanical complexity of the limbs, and eliminating potential failure points associated with sensor degradation, connector fatigue, or signal interference.

The continuous determination may run on a dedicated inference accelerator (e.g., a neural processing unit, a graphics processing unit, or a field-programmable gate array configured for inference), or on a heterogeneous combination of processing elements that dynamically share the inference workload based on current computational availability. The inference accelerator may be selected based on the power budget, thermal envelope, and latency constraints of the robot 1, with lower-power accelerators (e.g., edge-optimized neural processing units) preferred for battery-operated configurations and higher-throughput accelerators (e.g., graphics processing units) preferred for tethered or high-performance configurations. In some embodiments, a hybrid batch-then-online smoothing approach is used, where a short sliding window of recent observations is solved via bundle adjustment to establish a locally optimal state estimate, and the resulting state is then propagated forward in time by a Kalman-type filter (e.g., an extended Kalman filter or an unscented Kalman filter) that incorporates each new observation incrementally with minimal latency. The sliding window length may be adaptively adjusted based on the rate of motion of the tracked components, with faster-moving components receiving a shorter window to reduce estimation lag and slower-moving or stationary components receiving a longer window to improve estimation smoothness and reduce noise. In alternative embodiments, the system may employ a factor graph-based optimization framework in which each new observation is incorporated as a factor into a growing graph, and incremental optimization algorithms (e.g., incremental smoothing and mapping) are applied to update the state estimate efficiently without resolving the entire history. In further embodiments, the factor graph may incorporate marginalization of older states to bound the computational cost of optimization as the graph grows, retaining the informational contribution of marginalized states as a prior factor on the remaining active states.

In some embodiments, the real-time position determination process is configured to prioritize the estimation of components that exhibit the highest estimation uncertainty, directing the limited computational budget toward the position determinations that will yield the greatest improvement in task accuracy. The prioritization may be performed using a scheduling algorithm that ranks each component's estimation uncertainty against a running average and allocates additional inference cycles to components whose uncertainty exceeds a configurable threshold. The scheduling algorithm may further incorporate a task-relevance score that weights components based on their proximity to the current manipulation target, their role in the current phase of the task plan, and their kinematic coupling to other high-priority components, ensuring that components actively engaged in a task receive preferential computational allocation over components that are idle or in transit. In further embodiments, the scheduling algorithm may implement a priority decay function that gradually reduces the priority of a component after it has received a burst of additional inference cycles, thereby preventing computational starvation of lower-priority components and ensuring that all components receive a baseline level of estimation refresh. The scheduling algorithm may also account for the expected information gain from each potential observation, allocating inference cycles preferentially to components and viewpoints that are expected to yield the greatest reduction in pose uncertainty per unit of computation. In some embodiments, the scheduling algorithm may operate in concert with a camera selection module that determines which of the available cameras should be used to observe each component at each time step, selecting the camera that provides the most favorable viewing angle, the least occlusion, and the shortest distance to the component of interest.

v. Feeding Position Data to the Onboard AI System for Control

The positions and orientations determined by the BSPM serve as the primary perceptual input from which the onboard AI system generates motor commands, thereby translating spatial perception into physical action. The onboard AI system receives a concatenated token sequence comprising visual tokens produced by the BSPM's multiscale stereo network and proprioceptive state tokens from the state and force memory 4104. The concatenation may be performed along a feature dimension, a temporal dimension, or both, and the resulting composite sequence may be processed by a transformer-based, recurrent, or hybrid architecture that attends to both the spatial relationships among tokens and the temporal evolution of the composite state. From this fused representation, the onboard AI system generates action commands that are decoded into motor signals for the robot's actuators, forming a persistent sensorimotor feedback loop that operates continuously throughout each task and enables the robot 1 to ascertain and adjust the positions of its parts and components in real time.

This closed-loop architecture supports operation across a wide range of speeds and precision requirements. Action commands may be generated at a high control rate (e.g., 200 Hz, 500 Hz, or 1 kHz) and temporally compressed for accelerated execution, where temporal compression denotes the mapping of a nominal trajectory duration to a shorter execution duration while preserving the spatial path. The control rate may be dynamically adjusted based on the complexity of the current motion segment, with higher rates applied during fine-positioning phases and lower rates applied during gross transport phases to conserve computational resources. During rapid motions, the BSPM's continuous position output provides a correction signal that enables the onboard AI system to detect and compensate for structural flex, limb deflection, vibrational modes, and centrifugal and Coriolis effects arising at higher velocities. In some embodiments, the system employs a model-predictive control framework that uses the BSPM's position and velocity estimates, together with a learned or analytical dynamics model of the robot, to compute an optimal control-input sequence over a receding time horizon that minimizes a cost function encoding positional accuracy, energy expenditure, and actuator effort. In further embodiments, the model-predictive control framework may incorporate constraint terms that enforce joint position limits, joint velocity limits, and actuator torque limits, ensuring that the computed control-input sequence respects the physical operating envelope of the robot 1 at each time step of the prediction horizon.

The BSPM's position data further enables precise end-effector control for grasping and manipulating objects. For example, in a package handling task as depicted in FIG. 12, the robot 1 transfers packages between conveyor belts while ensuring each package's shipping label is oriented for scanning by a downstream barcode reader or optical character recognition system. The BSPM provides the spatial coordinates of the robot's end-effectors relative to the package surface, allowing the onboard AI system to adjust contact force, approach angle, and grasp aperture during manipulation. The continuous position feedback enables the system to fine-tune the grasp pose in response to changes in object state—such as deformation of a soft package, a shift in center of mass due to contents settling, or a change in surface friction due to moisture or contamination—and to detect and compensate for object slippage by monitoring relative displacement between the end-effector and the grasped object and adjusting gripper closure force or wrist orientation to restore a secure grasp. In some embodiments, the system may maintain a slippage detection model that monitors the rate of change of the relative displacement between the end-effector and the grasped object, and when the rate exceeds a configurable slippage threshold, the system may trigger an immediate increase in gripper closure force and a re-estimation of the object's center of mass to stabilize the grasp.

More generally, the onboard AI system may use the BSPM's position data in conjunction with a learned manipulation policy that maps the current spatial state and task objective to an optimal sequence of motor commands. The learned manipulation policy may be trained via imitation learning from expert demonstrations, via reinforcement learning in simulated or real environments, or via a combination in which imitation learning provides a behavioral prior that is subsequently refined through reinforcement learning. The policy may receive as input the BSPM's pose estimates together with associated uncertainty estimates, estimated velocities and accelerations of tracked components, and a representation of the task goal (e.g., a target pose for the manipulated object), allowing it to adapt its behavior to the current level of perceptual confidence and the kinematic constraints of the task. In some embodiments, the learned manipulation policy is structured as a hierarchical policy comprising a high-level task planner that selects among discrete manipulation primitives (e.g., approach, grasp, lift, transport, place, release) and a low-level motor controller that generates continuous joint-level or Cartesian-space commands to execute each selected primitive, with the BSPM's position data serving as the shared perceptual state representation consumed by both levels of the hierarchy. This policy-based approach enables the robot 1 to perform complex manipulation sequences including reorienting objects in-hand, inserting components into receptacles with tight tolerances, threading cables or fasteners, and executing multi-step assembly operations involving coordinated bimanual manipulation. In further embodiments, the learned manipulation policy may include a recovery sub-policy that is activated when the onboard AI system detects that the current manipulation action has failed (e.g., a dropped object or a missed insertion), and the recovery sub-policy may use the BSPM's position data to assess the post-failure state and plan a corrective sequence of actions to return to a state from which the original task can be re-attempted.

vi. Enhanced Position Determination and Tracking

To enhance the accuracy and depth perception of the position determination, the BSPM may incorporate a stereo vision backbone. Rather than relying on monocular visual input—-which limits the ability to perceive depth and spatial relationships —the system merges features from two or more stereo cameras within a multiscale stereo network before tokenization. This stereo fusion preserves the geometric correspondence between left and right camera views, enabling the BSPM to learn disparity-aware feature representations that improve depth estimation accuracy. The multiscale stereo network produces feature maps at three or more resolution levels, and each resolution level independently contributes disparity-aware tokens, ensuring that both fine-scale edge features and coarse-scale contextual features inform the position determination. This provides a comprehensive spatial representation across the full range of observed scales.

The stereo backbone may be further enhanced by a feature pyramid network (FPN) to facilitate multiscale representation learning. This hierarchical feature extraction allows the BSPM to balance fine-detail perception ——needed for precise keypoint localization—with comprehension of high-level scene structure—needed for understanding the spatial relationships among multiple parts and components. The FPN may produce feature maps at four or more levels, with each level corresponding to a spatial resolution that is half the resolution of the preceding level, and the features at each level may be combined through top-down connections and lateral connections that fuse high-resolution spatial detail with low-resolution semantic context. In alternative embodiments, the stereo vision backbone may be replaced with or supplemented by a learned monocular depth estimation network that infers depth from a single camera view using geometric and semantic cues, enabling depth-aware position determination even when only a single camera is available or when one camera in a stereo pair experiences a temporary fault. In further embodiments, the system may employ a cost volume-based stereo matching approach in which the stereo features from the left and right cameras are correlated at a plurality of disparity hypotheses to construct a three-dimensional cost volume, and a three-dimensional convolutional network processes the cost volume to produce a dense disparity map from which depth is computed.

To improve the continuity and robustness of the position determination, the system incorporates a vision memory module 4102 that maintains a short-term visual memory. Rather than determining positions from instantaneous camera frames alone, the BSPM composes features from a sequence of recent video frames (T-n, T-1, T), providing a temporal view of the positions of the robot's parts and components. This temporal context allows the onboard AI system to track the movement of parts and components over recent time steps and to maintain spatial continuity across control cycles. The vision memory module 4102 may implement a learned temporal attention mechanism that assigns different weights to each frame in the sequence based on its relevance to the current position determination, ensuring that the most informative historical observations exert the greatest influence. In further embodiments, the vision memory module 4102 may employ a recurrent architecture, such as a gated recurrent unit (GRU) or a long short-term memory (LSTM) cell, to maintain a compressed representation of the temporal history that is updated incrementally as new frames arrive. In yet further embodiments, the vision memory module 4102 may maintain a keyframe buffer that stores a sparse set of past frames selected for their high information content (e.g., frames captured from diverse viewpoints or frames in which a large number of keypoints were detected with high confidence), and the temporal attention mechanism may preferentially attend to these stored keyframes to provide long-range temporal context beyond the immediate sliding window of recent frames.

The system further incorporates state and force memory 4104, which augments the BSPM's position outputs with a history of recent proprioceptive states, including hand, torso 16, and head 10.1 positions. This state history ensures continuity between discrete control actions and provides a baseline against which the current state can be compared. Force feedback is also integrated, providing a touch proxy that enables the onboard AI system to combine the BSPM's visual position determination with tactile sensing. By detecting contact events and modulating grip force or motion based on sensed resistance, the system achieves more precise control of the robot's parts and components during object manipulation. In some embodiments, the state and force memory 4104 includes a learned anomaly detector that identifies when the current force profile deviates from the expected distribution for a given action, triggering a protective response. The anomaly detector may be implemented as a lightweight autoencoder, and a reconstruction error exceeding a learned threshold triggers the protective response, such as reducing movement velocity, opening the gripper, or transitioning to a safe holding posture. In further embodiments, the anomaly detector may maintain a library of expected force profiles indexed by action type and object category, and the expected distribution for the current action may be retrieved from the library based on the current task context, enabling the anomaly detector to adapt its sensitivity to the specific characteristics of the object being manipulated.

c. Self-Positioning with Sensor Fusion

The preceding sections describe how the BSPM determines the position of the robot's parts and components from camera images and delivers that position data to the onboard AI system. To further enhance the accuracy and robustness of its position estimates, the BSPM may fuse camera-derived data with data from one or more additional sensor types. Specifically, the BSPM may implement sensor fusion algorithms that combine data from at least two different sensor modalities to determine the position and orientation of one or more components of, or the entirety of, the humanoid robot 1. The sensor fusion approach enables pose estimation performance that exceeds what any individual sensor can achieve alone. This performance gain arises from the statistical and physical complementarity of the fused sensor signals. Each sensor type provides distinct information with characteristic strengths and limitations, and understanding these characteristics is fundamental to designing effective fusion algorithms. For example, inertial measurement units (IMUs) provide high-bandwidth orientation data but suffer from cumulative drift over time, while joint encoders provide absolute position measurements but only at the joint axis. Neither sensor alone provides a complete picture of the robot state; by fusing their respective outputs, the BSPM may achieve estimation accuracy superior to either sensor individually.

The fusion algorithms may operate on heterogeneous data types including, without limitation, angular measurements, linear accelerations, force vectors, image coordinates, and contact pressure distributions. To process these heterogeneous inputs, the BSPM may employ one or more estimation frameworks selected from the group consisting of Kalman filters, particle filters, factor graphs, and neural network-based estimators. The selection of a particular estimation framework may depend on one or more of: the dimensionality of the state space, the degree of nonlinearity in the measurement models, and the computational budget available on the robot's onboard processing hardware. The fusion algorithms may be configured for self-supervised and online positioning, wherein positioning parameters are updated in real time without human intervention or dedicated calibration procedures. In at least one embodiment, the BSPM correlates measurements from various sensors with known reference points or known motion patterns to identify and correct sensor biases during operation. The BSPM may maintain a total fusion latency of less than 5 milliseconds, and preferably less than 1 millisecond, thereby enabling responsive closed-loop control of the robot 1. The position estimates produced by the sensor fusion process are delivered to the onboard AI system for use in generating motor commands, consistent with all other position data produced by the BSPM. The following subsections describe specific sensor data combinations and the methods by which they may be fused, along with the advantages and implementation considerations for each combination.

As illustrated in FIG. 4, the robot 1 comprises a plurality of sensors 1.2.8 embodied as hardware, software, firmware, and/or circuitry for generating sensor data indicative of perceived stimuli, environmental conditions, and physical measurements. The BSPM receives multi-modality sensory data from the sensors 1.2.8. The multi-modality sensory data may include, without limitation, inertial measurements, visual imagery, depth maps, force and torque readings, tactile pressure distributions, thermal signatures, and spectral reflectance profiles. The sensors 1.2.8 may be distributed across the body of the robot 1, with each sensor positioned to provide maximum observability of the component or environment region it is configured to monitor.

In various embodiments, the BSPM may select a subset of available sensor modalities for fusion based on one or more of: the current task being performed by the robot 1, characteristics of the operating environment, and the computational resources currently available. This adaptive sensor management balances estimation performance against power consumption and processing load. The BSPM may further implement a sensor health monitor that continuously evaluates the noise characteristics and update rate of each connected sensor modality. When the output statistics of a given sensor deviate beyond a predetermined threshold from its nominal operating specification, the sensor health monitor may deactivate or down-weight that sensor's contribution to the fused position estimate, thereby preventing degraded sensor data from corrupting the overall estimation. In further embodiments, the sensor health monitor may maintain a per-sensor degradation log that records each instance in which a sensor's output statistics deviate from the nominal specification, and the accumulated degradation history may be used to schedule predictive maintenance for sensors that exhibit a trend of increasing deviation.

i. Inertial Measurement Units

The electronics assembly can be configured to include Inertial Measurement Units (IMUs) on articulated segments of the hand, such as the distal, medial, and proximal assemblies of each finger, to detect and track motion, position, and orientation with high fidelity. Each IMU may incorporate micro-electromechanical systems (MEMS) accelerometers, gyroscopes, and, in some embodiments, magnetometers, providing a compact and lightweight alternative to traditional encoders in space-constrained joints. The BSPM may selectively enable or disable the magnetometer channel based on the detected level of magnetic interference in the operating environment. By integrating these inertial sensors across the articulated segments, the system enables reconstruction of complete kinematic chains relative to the global gravity vector and the robot palm, supporting fingertip position estimation even in the absence of direct joint encoders. In some embodiments, the IMUs may be implemented as system-in-package devices that combine the MEMS sensing elements, an application-specific integrated circuit for signal conditioning and digitization, and a microcontroller for local bias compensation and data timestamping, all within a single package having a volume of less than 10 mm3.

The BSPM may fuse the IMU data with data from the visual sensors 1.2.8.6 (e.g., the cameras 108.2.2 and 108.2.4 in the head 10.1 and/or the hand-mounted cameras 108.2.6 and 108.2.8) to determine the position of each finger assembly, combining high-rate inertial sensing with drift-free visual observation. This fusion addresses the fundamental trade-off between update rate and long-term accuracy inherent in each sensor type. The IMUs provide high-rate orientation and angular velocity measurements (e.g., 500 Hz to 1000 Hz) that capture rapid finger motions with low latency (typically under 0.5 milliseconds for data acquisition and preprocessing), but accumulate drift over time due to gyroscope bias and accelerometer noise, limiting their standalone accuracy over extended periods. The high update rate also enables detection of transient vibrations, impact events, and rapid finger accelerations—such as those encountered when grasping a fast-moving tool—that would otherwise be missed by lower-frequency visual systems, enabling high-speed closed-loop finger positioning and rapid protective responses that reduce the risk of damage to the robot's fingers or the manipulated object. The cameras provide absolute position measurements of the finger assemblies through visual observation at lower update rates (e.g., 30 Hz to 120 Hz) and with higher latency (e.g., 10 to 50 milliseconds for image capture and processing). By fusing these complementary data sources, the robot 1 may achieve both the high-bandwidth tracking capability of the IMUs and the drift-free absolute positioning of the cameras, with the fused estimate achieving position accuracy comparable to the camera measurements while maintaining the low latency of the IMU measurements. The fusion may adaptively weight each sensor's contribution based on the estimated reliability of its current output.

The BSPM mitigates sensor-specific limitations through a multi-step prediction and update architecture that leverages the kinematic constraints of the robot hand. The prediction step propagates the orientation state using bias-corrected angular velocity at the IMU rate, where the quaternion derivative is computed from the bias-corrected angular velocity, the velocity derivative is computed from the rotated and bias-corrected acceleration minus gravity, and the position derivative equals velocity, implementing the kinematic equations of motion. This prediction step executes in under 0.1 milliseconds per assembly on modern embedded processors, enabling high-rate state propagation that tracks rapid finger motions without lag. The update step utilizes gravity vector observations during static or quasi-static phases as a reference to correct accumulated integration errors. As used herein, the term “quasi-static” refers to motion phases in which the robot's translational acceleration is sufficiently small (e.g., below 0.5 m/s² or another configurable threshold) that the accelerometer output is dominated by the gravity component rather than by dynamic acceleration, making the gravity vector observation reliable for orientation correction. The system may further exploit the known range of motion of individual joints to reject off-axis noise and non-physical accelerations, thereby enhancing the stability of primary axis estimation.

In some implementations, the fusion may be implemented using a loosely-coupled Extended Kalman Filter (EKF) architecture that maintains separate processing paths for the IMU and camera data with periodic fusion updates. The EKF may maintain a state vector comprising the orientation (represented as a quaternion), angular velocity, position, linear velocity, and gyroscope bias for each finger assembly, and in some embodiments, the state vector may be augmented with accelerometer bias terms, enabling estimation of sensor-specific offsets that may change over the operational lifetime of the robot 1 due to temperature variations or aging effects. When camera measurements become available, the EKF performs a measurement update that corrects accumulated drift. The visual sensors 1.2.8.6 may detect micro-scale UV/IR patterns or micro-printed fiducials applied to surfaces of the finger assemblies, which are detectable by the robot cameras but unobtrusive to users, preserving the cosmetic appearance of the hand. The measurement residual (innovation) is computed as the difference between the observed keypoint position and the predicted keypoint position based on the current state estimate and the known kinematic model, and the Kalman gain determines the correction applied to the state estimate based on the relative confidence in the prediction versus the measurement. To achieve sub-millisecond fusion latency, the Kalman gain may be precomputed or approximated using steady-state values when the camera frame rate is constant, eliminating the matrix inversions that would otherwise dominate the computation time. In alternative embodiments, the Kalman gain may be recomputed at each measurement update using a Joseph-form covariance update that provides improved numerical stability for finite-precision arithmetic, which may be preferred when noise characteristics vary over time.

In an alternative embodiment, the fusion may be implemented using IMU pre-integration, which aggregates high-rate IMU measurements between camera frames into a single relative motion constraint. The pre-integrated IMU measurement represents the relative rotation, velocity change, and position change accumulated between camera frames, and the pre-integration formulas account for the rotation of the acceleration measurements into a common reference frame. The pre-integrated measurements are treated as observations in a factor graph optimization that jointly estimates the finger assembly poses at each camera frame along with the IMU biases, enabling smooth trajectory estimation with latency under 1 millisecond for the IMU propagation and under 5 milliseconds for the periodic optimization updates. This approach also improves robustness to camera frame drops by accumulating IMU measurements across multiple camera update intervals. In some embodiments, the factor graph may incorporate additional factors representing kinematic constraints between adjacent finger assemblies, such as shared palm attachment points or coupled tendon routing, improving estimation accuracy for partially occluded assemblies by enforcing consistency across the kinematic chain. In further embodiments, the factor graph may include loop closure factors that link the current state estimate to a previously observed state when the hand returns to a known configuration, reducing long-term drift in scenarios involving repetitive motions. In yet further embodiments, the pre-integration may be performed using a Runge-Kutta numerical integration scheme of order four or higher, which provides improved integration accuracy relative to the first-order Euler integration at a modest increase in computational cost, and the pre-integration may also propagate the covariance of the pre-integrated measurement to enable the factor graph optimizer to account for the noise accumulated during the pre-integration interval.

The utilization of intelligent sensor hubs within each digit allows the robot 1 to process drift-corrected quaternions locally, reducing the computational burden on the main whole-body controller. In alternative embodiments, the sensor hubs may perform local outlier rejection by comparing successive IMU readings against kinematic feasibility bounds derived from the maximum joint velocity and acceleration, discarding measurements that fall outside these bounds before transmission to the BSPM. The resulting position and orientation estimates are delivered to the onboard AI system, which uses them to generate the motor commands that control the robot's fingers during manipulation tasks. For locomotion, IMUs placed in the feet provide feedback for ground impact detection and orientation tracking on uneven terrain, allowing the robot 1 to adjust its balance and gait to compensate for surface slippage or unexpected obstacles. In some embodiments, the foot-mounted IMUs may detect the moment of heel strike and toe-off during each gait cycle, and the detected gait phase transitions may be provided to the locomotion controller to synchronize the control actions with the natural rhythm of the gait.

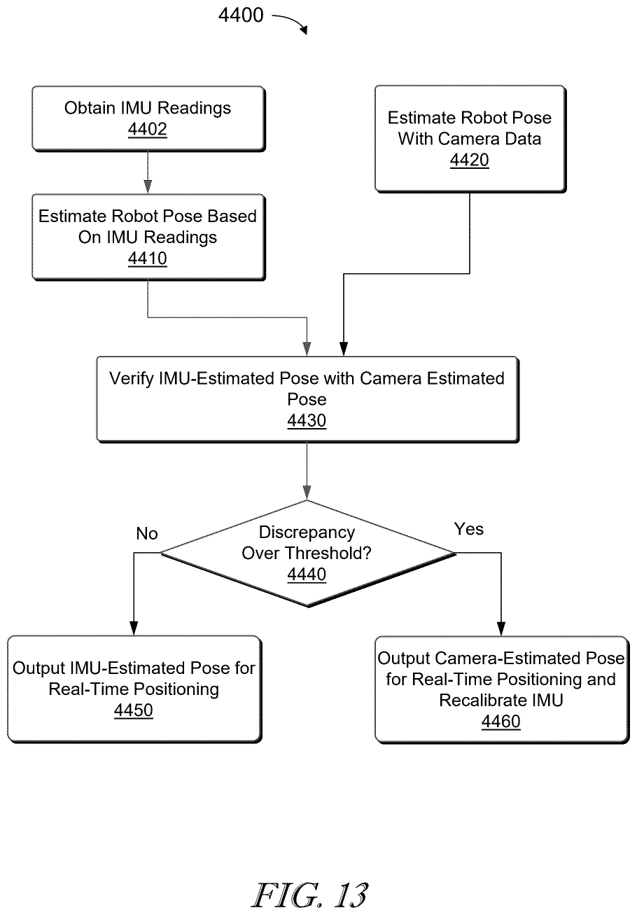

FIG. 13 illustrates a method 4400 for self-positioning that integrates IMU and camera fusion, using a camera-estimated pose as verification for an IMU-based pose. The method 4400 may begin at block 4402, where the system obtains IMU readings from the inertial sensors 1.2.8.4. At block 4410, the system estimates a robot pose based on the obtained IMU readings. In parallel, at block 4420, the system estimates the robot pose with camera data obtained from the visual sensors 1.2.8.6. At block 4430, the system verifies the IMU-estimated pose against the camera-estimated pose as a continuous check against IMU drift. At block 4440, the system determines whether a discrepancy between the IMU-estimated pose and the camera-estimated pose exceeds a predefined threshold. If the discrepancy does not exceed the threshold, indicating the IMU data remains reliable, the method 4400 proceeds to block 4450 to output the IMU-estimated pose for real-time positioning. If the discrepancy exceeds the threshold, the method 4400 advances to block 4460 to output the camera-estimated pose for real-time positioning and readjustment of the IMU biases, ensuring long-term positional accuracy without sacrificing high-frequency tracking. In some embodiments, the predefined threshold at block 4440 may be parameterized as a function of the current task precision requirements, with tighter thresholds enforced during fine manipulation and relaxed thresholds permitted during gross locomotion.

ii. Encoders

Similarly, the integration of joint encoder data with camera data can also provide a robust layer of absolute positioning accuracy that is particularly effective for addressing transmission backlash and structural compliance issues. While encoders measure the rotation about a specific joint axis with high resolution, they primarily provide internal relative measurements that cannot inherently account for structural deformations of the robot limbs or external link-side positioning errors. The camera system can be configured to observe the actual spatial position of robot assemblies relative to the world frame or other key robot segments, providing a visual anchor that serves as an external ground truth for the encoder-based kinematic chain. This combination allows the robot 1 to benefit from the high-resolution, zero-drift relative sensing of encoders while using visual feedback to dynamically correct for mechanical variances that occur outside the encoder's sensing range, such as frame bending under load or gear tooth backlash. In alternative embodiments, the camera data may be supplemented with depth data from a ToF sensor co-located with the camera, and the combined RGB-D observation may provide both 2D keypoint positions and direct 3D depth measurements, enabling more constrained and accurate pose estimation than either modality alone.

Fusing these two modalities involves using the camera's absolute position measurements to verify the forward kinematics derived from the encoder values. The system can be configured to map the expected visual keypoint locations based on current encoder angles and then compare these projections to the actual observed keypoints in the camera feed. Any persistent discrepancy between the expected and observed visual state can be attributed to kinematic biases, backlash, or thermal expansion. The benefits of this fusion include the ability to maintain sub-millimeter positioning accuracy over long-duration tasks without the robot 1 needing to return to a fixed jig, and the resulting position data enables the onboard AI system to maintain precise control of the robot's parts and components even as the robot's mechanical properties change over time.

In some embodiments, the BSPM may maintain a running history of encoder-camera discrepancies over a sliding time window, and the statistical properties of these discrepancies (e.g., mean offset, variance, and trend) may be used to distinguish between systematic drift and transient disturbances such as mechanical shock or vibration. The BSPM may further classify the detected discrepancy pattern into one of a set of predefined categories (e.g., linear drift, periodic oscillation, step change, or random noise) using a lightweight pattern classifier, and the classification may inform the selection of the most appropriate correction strategy for each category. In further embodiments, the BSPM may generate a discrepancy trend report at configurable intervals (e.g., hourly, daily, or per-shift), enabling maintenance personnel to monitor the health of the robot's mechanical transmission and to schedule preventive maintenance before a drift trend exceeds operational tolerances. In additional embodiments, the discrepancy trend report may include a remaining-useful-life estimate for each monitored transmission component, computed from the observed trend slope and the maximum allowable discrepancy for the component's operational role.

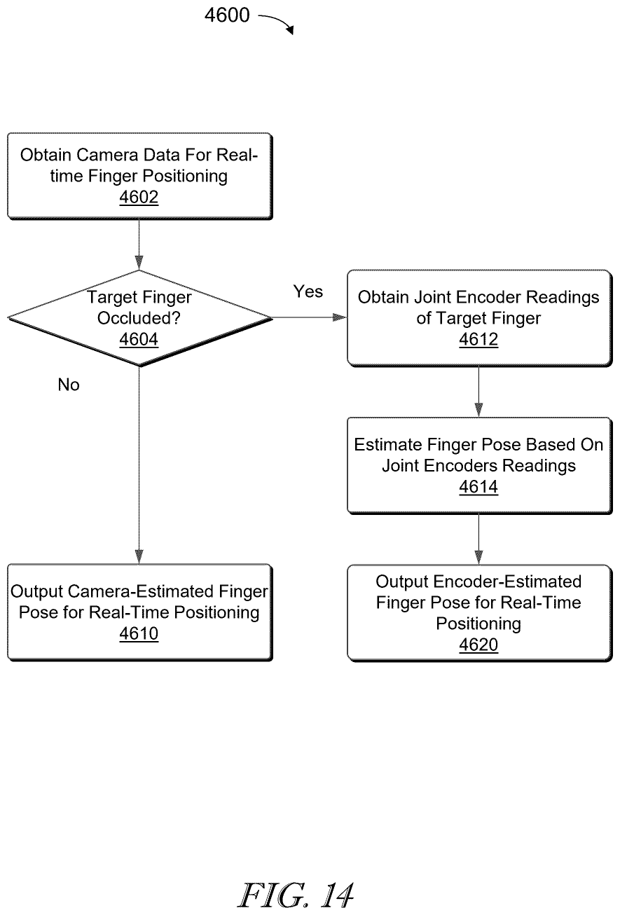

FIG. 14 illustrates a method 4600 for self-positioning that integrates joint encoder and camera fusion, with a specific focus on finger pose estimation. Accurate finger positioning is valuable for intricate manipulation tasks, particularly for home tasks where the hands of the robot 1 interact with diverse and unstructured objects. During these home tasks, the fingers can be easily occluded from the view of the head-mounted or wrist-mounted cameras. The method 4600 addresses this challenge by using encoders to complement the visual data. At block 4602, the system obtains camera data for real-time finger positioning. At block 4604, the system determines if the target finger is occluded in the camera data. The occlusion determination at block 4604 may be performed by evaluating the number of detected keypoints on the target finger against a minimum visibility threshold, or by applying a learned occlusion classifier that operates on the image region corresponding to the expected finger location. If the target finger is not occluded, the method 4600 proceeds to block 4610 to output the camera-estimated finger pose for real-time positioning. If the target finger is occluded, the system relies on internal kinematic sensors to complement the missing visual data. In this scenario, the method advances to block 4612 to obtain joint encoder readings of the target finger. Based on these readings, at block 4614, the system estimates the finger pose based on the joint encoder readings. The method 4600 then concludes at block 4620 by outputting the encoder-estimated finger pose for real-time positioning. In both cases, the resulting finger pose is delivered to the onboard AI system, ensuring that the robot 1 always has the spatial data it needs to control its fingers, whether or not the cameras can see them.

In alternative implementations, joint encoders can be difficult and expensive to implement on the small, densely packaged joints of the fingers. In such cost-constrained or space-constrained embodiments, the physical encoders may be omitted entirely from the fingers, and the system may rely primarily on the cameras, such as head-, wrist-, and/or palm-mounted cameras to estimate the poses of the fingers, utilizing predictive kinematic models and historical state data to bridge brief periods of visual occlusion. The predictive kinematic model may propagate the last known finger pose forward in time using the commanded motor currents and a learned relationship between motor current and joint velocity, providing a coarse estimate that is refined as soon as visual observation is restored. In further embodiments, the system may employ a hybrid approach in which encoders are installed on a subset of finger joints (e.g., the proximal joint of each finger) while the remaining joints (e.g., the medial and distal joints) are estimated from camera observations and predictive models, balancing the trade-off between hardware cost, packaging volume, and estimation accuracy. In yet further embodiments, the learned relationship between motor current and joint velocity may account for load-dependent friction and tendon elasticity by incorporating the estimated joint torque as an additional input, enabling the predictive model to maintain accuracy even when the finger is in contact with an object and experiencing external forces.

iii. Time-of-Flight Sensors

The robot vision system can be configured to incorporate time-of-flight (ToF) sensors to provide direct, high-resolution depth measurements of the surrounding environment and the robot's own assemblies. These sensors allow the robot 1 to capture 3D information by measuring the precise time taken for emitted light signals, typically in the infrared spectrum, to return from observed surfaces, facilitating keypoint localization and obstacle detection. By fusing ToF depth data with traditional RGB imagery, the system can achieve sub-millimeter positioning accuracy of end-effectors, as the direct depth sensing overcomes the resolution and aliasing limitations inherent in purely triangulation-based stereo vision. The ToF sensors may operate at frame rates ranging from 30 Hz to 300 Hz, with depth resolution on the order of 1 millimeter or less at working distances under 2 meters. In manipulation applications, such as threading a needle or performing delicate assembly, the ToF sensor provides a dense point cloud that allows the robot 1 to visualize the exact spatial relationship between its fingers and the target object, enabling the refinement of grasp planning based on real-time surface geometry.

The integration of ToF sensors allows the BSPM to handle challenging imaging scenarios where traditional visual cues, such as edges or textures, may be ambiguous or absent. For instance, the system can sample depth values directly from aligned depth images to verify the spatial coordinates of detected visual keypoints or fiducial markers on the robot's limbs. This configuration provides a favorable trade-off between spatial resolution and acquisition speed, enabling the robot 1 to maintain stable proprioception during rapid dynamic motions or high-speed locomotion. The resulting filtered point clouds allow for the detection of subtle contact events by monitoring for sudden changes in depth at the contact interface, which can be fused with tactile sensor data to refine the robot's understanding of object impedance. In some embodiments, the BSPM may apply temporal filtering techniques such as exponential moving averages or median filters to the raw ToF depth data to reduce measurement noise while preserving edge fidelity at object boundaries. For locomotion tasks such as climbing stairs, the ToF sensor provides a reliable depth map of the step edges, allowing the navigation stack to calculate precise foot placements and avoid tripping over structural hazards that might be misidentified by 2D cameras. In a further embodiment, the ToF sensor may operate in a multi-frequency mode in which measurements at two or more modulation frequencies are combined to resolve depth ambiguities and extend the unambiguous measurement range beyond the limit imposed by a single modulation frequency. In alternative embodiments, the ToF sensor may be supplemented with a structured-light illuminator that projects a coded pattern onto the scene, enabling the system to achieve higher spatial resolution in regions of particular interest, such as the immediate workspace of the end-effector.

iv. Thermal Imaging

Furthermore, the fusion algorithms can be configured to fuse thermal imaging data with standard RGB camera feeds to enhance object detection and assembly tracking, particularly in low-light or variable thermal environments. This multi-modal approach allows the robot 1 to identify and localize objects based on their thermal signatures, which provides a reliable detection modality when visible light is insufficient or when objects lack distinctive visual texture. By correlating thermal features with RGB keypoints, the system can maintain robust state estimation across a wider range of operating conditions, ensuring that robot limbs and external targets remain observable during transitionary lighting phases or in complete darkness. The thermal sensor may capture data in the long-wave infrared (LWIR) band, typically spanning wavelengths from 8 to 14 micrometers, and the BSPM may register the thermal image to the RGB image using a pre-aligned homography or stereo extrinsic transformation. In industrial manipulation settings, the fusion of thermal data can allow the robot 1 to detect the temperature of workpieces, facilitating tasks such as sorting hot components from cold ones or identifying active electronic devices that generate a distinct heat profile.

This fusion provides a technical solution for identifying heat-generating components or humans in the workspace, enhancing the overall safety and awareness of the robot 1 during collaborative tasks. The thermal sensor data can be mapped into the common robot-centric coordinate frame alongside visual data, allowing the whole body controller to implement adaptive safety zones that move with detected thermal sources. This configuration provides the robot 1 with the ability to maintain consistent tracking of its own hand assemblies by detecting the thermal emissivity of internal electronics or actuators, serving as a redundant verification signal that complements visual fiducials. In some embodiments, the BSPM may assign a thermal confidence score to each detected entity based on the stability and magnitude of the thermal signature, and this confidence score may modulate the safety zone radius such that higher-confidence detections of humans trigger larger standoff distances. In locomotion, thermal sensors can be utilized to detect “hot spots” in a disaster recovery environment or to identify organic life forms in search-and-rescue operations, allowing the robot 1 to prioritize its movement toward heat signatures that indicate the presence of survivors. The combination of RGB and thermal modalities reduces false positive detections caused by shadows or visual occlusions, as the thermal signal provides an independent confirmation of object presence. In further embodiments, the thermal fusion system may implement a temporal persistence filter that tracks the stability of thermal signatures over successive frames, differentiating between stationary heat sources (e.g., a heated surface) and transient thermal events (e.g., a brief reflection from a warm air current), improving the specificity of thermal-based detection. In additional embodiments, the thermal sensor may capture data at two or more sensitivity settings in an alternating pattern, with a high-sensitivity setting for detecting low-contrast thermal features and a low-sensitivity setting for avoiding saturation when observing high-temperature objects, and the BSPM may select the most informative capture for each detected entity based on the entity's thermal magnitude.

v. Structured Light Projectors

In environments characterized by texture-less or monochromatic surfaces, the robot 1 can be configured to utilize structured light projectors for active depth sensing and surface mapping. This technology allows the system to project known patterns, such as encoded grids, stripes, or pseudo-random dots, onto the environment to create artificial visual features that the cameras can track with high precision. By observing the deformation of these projected patterns as they drape over objects, the BSPM can calculate the depth and surface topology of objects that would otherwise remain invisible to traditional passive vision systems. This provides the high-density spatial data for precision manipulation of smooth, untextured items like polished plastic housings or metallic plates during assembly tasks. The structured light projector may employ infrared wavelengths to avoid interference with the RGB camera feed, and the projected pattern may be modulated in time (e.g., using phase-shifted sinusoidal fringes) to achieve sub-pixel depth resolution.

The active sensing approach provides the robot 1 with the ability to perform accurate keypoint localization on smooth or reflective surfaces of its own limb assemblies, where passive lighting may create ambiguous glints. The system can be configured to scan these projected patterns to monitor structural deformations or limb bending in real-time, allowing the kinematic model to adjust for load-induced compliance and maintain end-effector accuracy. This integration allows for robust 3D reconstruction even in challenging indoor lighting conditions where shadows might obscure object edges. In manipulation, structured light can be fused with haptic feedback to verify the geometry of an object before and after a grasp, ensuring that the object has not deformed under pressure. In alternative embodiments, the structured light system may employ multiple projectors positioned at different angles relative to the cameras to reduce occlusion artifacts caused by surface discontinuities, and the BSPM may merge the depth maps from each projector-camera pair into a single consolidated point cloud. For locomotion, this technology provides the robot 1 with the ability to navigate across featureless white floors or through dark, untextured corridors by actively creating the visual landmarks for simultaneous localization and mapping (SLAM) algorithms to function. In further embodiments, the structured light projector may employ a programmable pattern generator, such as a digital micromirror device or a liquid crystal on silicon modulator, that allows the projected pattern to be changed in real time based on the current sensing task, projecting a coarse pattern for rapid scene surveying and a fine pattern for high-resolution measurement of a specific region of interest.

vi. Hyperspectral Imaging

The BSPM can also be configured to integrate hyperspectral imaging sensors to provide material classification and enhanced object recognition capabilities beyond the visible spectrum. These sensors allow the robot 1 to analyze the spectral reflectance of surfaces across hundreds of narrow bands, enabling the identification of specific material properties such as metal, plastic, carbon fiber, or various types of organic matter. This spectral signature provides a unique data stream that can be used to distinguish between objects that appear visually identical in standard RGB imagery, thereby enhancing the reliability of grasp planning and automated sorting tasks. The hyperspectral sensor may capture data across a wavelength range spanning the visible through short-wave infrared (e.g., 400 nm to 2500 nm), and the BSPM may reduce the dimensionality of the spectral data using principal component analysis or learned spectral embeddings to enable real-time classification. For manipulation, the hyperspectral data provides the robot 1 with the ability to identify the “ripeness” of a fruit or the presence of surface coatings on a mechanical part, allowing it to adapt its grasp force to the specific material characteristics of the target object.

By incorporating hyperspectral data into the perception model, the robot 1 can better account for material-specific mechanical properties, such as friction coefficients and stiffness, during interaction. For example, the system can be configured to adjust gripping forces to prevent slipping on a wet metallic surface or to avoid crushing a fragile plastic component that was correctly identified through its spectral signature. This integration provides a high-dimensional feature space for machine learning-based recognition models, allowing the robot 1 to adapt its manipulation strategies to a broader variety of task-specific objects and environmental substrates. In some embodiments, the BSPM may maintain a spectral library that maps measured spectral signatures to material property records, and the library may be updated online as the robot 1 encounters new materials and correlates their spectral profiles with tactile feedback during manipulation. In locomotion, hyperspectral sensors can allow the robot 1 to identify the composition of the terrain, such as distinguishing between solid rock, loose sand, or slippery ice. This material-aware navigation allows the locomotion controller to choose gait patterns and foot-friction models that are optimized for the specific ground composition, significantly reducing the risk of fall events in complex outdoor environments. In further embodiments, the spectral library may include confidence intervals for each material property record, and when the measured spectral signature falls within the confidence interval of multiple candidate materials, the BSPM may report the set of candidate materials along with their respective likelihoods, enabling the onboard AI system to adopt a conservative manipulation strategy that is safe for the most fragile candidate material until further sensory evidence resolves the ambiguity.

vii. Radar Sensors

In some further implementations, to improve depth perception and object detection in adverse weather or dusty industrial conditions, the robot architecture can be configured to fuse visual data with radar-based sensors. Radar provides a reliable sensing modality that is unaffected by atmospheric interference such as fog, smoke, rain, or ambient light fluctuations, allowing the robot 1 to maintain awareness of its surroundings in environments where cameras might fail entirely. By merging high-resolution visual keypoints with radar-derived velocity and distance information, the system allows for more robust tracking of moving obstacles, collaborative partners, and large machinery. The radar sensor may operate in the millimeter-wave band (e.g., 60 GHz to 80 GHz) and may provide simultaneous range, angle, and Doppler velocity measurements with update rates of 10 Hz to 100 Hz. In locomotion, the radar sensor provides a long-range detection layer that can identify the movement of vehicles or people from hundreds of meters away, enabling the navigation system to plan safe paths that avoid dynamic hazards well in advance.

This configuration provides a redundant perception layer that enhances the safety and reliability of the robot's navigation and manipulation stacks. The radar data can be utilized to verify the depth estimates of visual keypoints, particularly at medium to long ranges where stereo vision accuracy begins to diminish exponentially with distance. The system is configured to correlate radar returns with the known geometry of the robot's limbs to provide an additional source of proprioceptive data that is immune to visual occlusions caused by dust or steam. This approach allows the robot 1 to operate in dynamic industrial settings, such as construction sites or mining tunnels, where sensor reliability is a prerequisite for autonomous operation. In some embodiments, the BSPM may employ a track-level fusion architecture wherein each sensor maintains independent object tracks, and the fusion module associates and merges tracks based on spatial and temporal proximity, enabling robust perception even when individual sensors produce intermittent detections. In manipulation, radar-based proximity sensing can provide a backup safety signal when the robot's arm enters a cluttered space where camera views are blocked, ensuring that the arm can stop before making an unintended contact with an unseen object or worker. In a further embodiment, the radar sensor may employ a frequency-modulated continuous wave (FMCW) waveform, and the beat frequency spectrum may be processed to extract both the range and the micro-Doppler signature of detected objects, enabling the BSPM to distinguish between static obstacles and moving entities such as humans or other robots based on their characteristic motion patterns. In alternative embodiments, the radar sensor may be implemented as a phased-array antenna that provides electronic beam steering, enabling the system to direct the radar beam toward regions of interest identified by the visual perception pipeline without physically repositioning the sensor. In further embodiments, the radar sensor may provide multi-target tracking capability by maintaining a bank of independent tracking filters, one for each detected object, and the BSPM may associate each radar track with a corresponding visual track based on position and velocity agreement, enabling the system to maintain persistent object identity even when one modality loses detection of a particular object.

viii. Ultrasonic Sensors

In addition, the electronics assembly can be configured to include ultrasonic sensors for short-range depth estimation and proximity detection, providing a low-cost and reliable safety layer. These sensors provide a technical solution for detecting transparent or reflective objects, such as glass partitions, clear plastic bottles, or polished metal surfaces, that may be difficult for optical, laser, or infrared-based sensors to resolve. By emitting high-frequency sound pulses and measuring the return echoes, the robot 1 can maintain a constant “safety bubble” around its limbs and end-effectors, facilitating safe interaction during proximity-based tasks. The ultrasonic sensors may operate at frequencies between 40 kHz and 200 kHz, with the BSPM selecting the operating frequency based on the desired range and angular resolution, where higher frequencies provide finer spatial resolution at the cost of reduced maximum detection range. In manipulation, ultrasonic sensors provide fine-grained distance measurements during the approach phase of a grasp, allowing for the precise adjustment of finger spread and orientation before physical contact is established, which is particularly beneficial for handling delicate or fragile items.

The integration of ultrasonic data provides a high-reliability modality for close-range sensing where camera focus may be insufficient or where the field-of-view is limited by the robot's own structure. The BSPM can be configured to utilize these sensors for detecting the presence of a human hand during a handover task, enabling the robot 1 to perform a smooth and safe transition of an object without needing a clear line-of-sight for the cameras. This configuration allows for the detection of subtle changes in the environment, such as the approach of a soft object or a change in the surface orientation of a target, providing the robot 1 with a responsive feedback loop for localized motion adjustments. In alternative embodiments, the ultrasonic sensors may be arranged in arrays to provide angular discrimination of detected objects through beamforming techniques, and the BSPM may combine readings from multiple ultrasonic elements to estimate both the range and bearing of nearby obstacles with improved accuracy. In locomotion, ultrasonic sensors placed at the base of the robot 1 can detect low-lying obstacles or drop-offs, such as a step or a curb, that might be hidden in the camera's blind spot. This short-range acoustic sensing provides a “floor-awareness” that complements the long-range visual mapping, ensuring that the robot 1 does not step into an unseen hole or collide with a transparent obstacle. In further embodiments, the ultrasonic sensors may be configured to operate in a pulse-echo mode for range measurement and in a continuous-wave mode for velocity measurement via the Doppler effect, and the BSPM may switch between modes based on whether the current task involves approaching a stationary object (pulse-echo mode) or tracking a moving object (continuous-wave mode).

ix. IMU, Encoder, and Camera Data Fusion

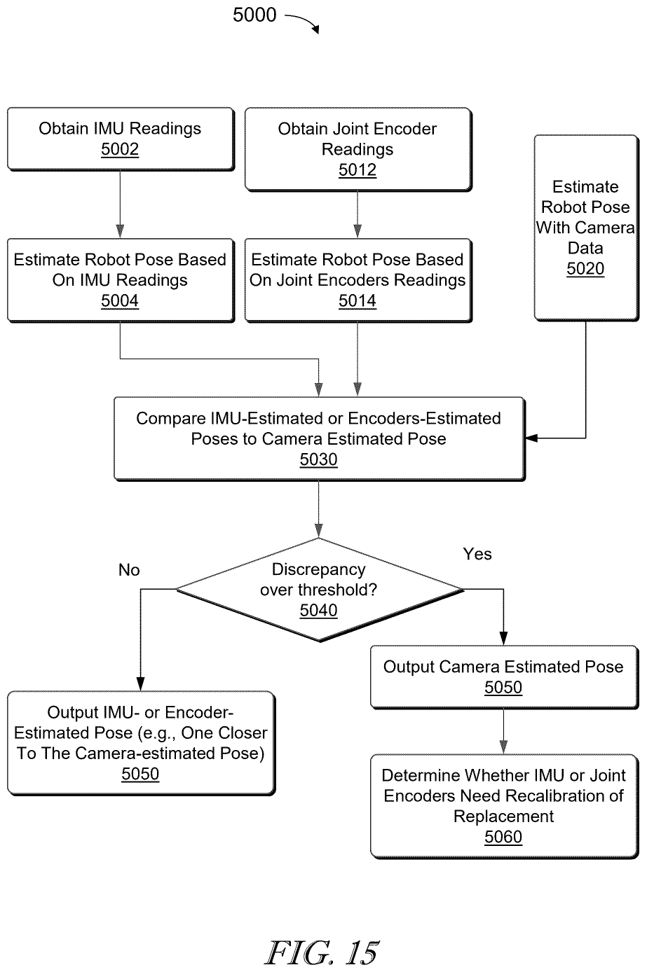

FIG. 15 is a flowchart illustrating a three-way sensor-fusion verification and positioning process 5000, which is configured to maintain sensor integrity through continuous monitoring. This process represents the most comprehensive fusion approach disclosed herein, combining all three primary sensor modalities to produce the highest-confidence position data for the onboard AI system. The three modalities—IMUs, joint encoders, and cameras—each contribute complementary information, and the fusion of all three provides redundancy that enables continued operation even when one modality is degraded. In some implementations, this process may begin with parallel data acquisition steps where the system is configured to obtain IMU readings at block 5002 and/or obtain joint encoder readings at block 5012. Following acquisition, the process illustrates bifurcated independent estimation paths, which serve as demonstrations of how the system can isolate modality-specific sensor errors. While these paths are shown as distinct branches, the BSPM can be configured to choose either path to execute independently or both paths concurrently, depending on the specific sensor health monitoring conditions.

For instance, the system may selectively execute the first path to estimate robot pose based on IMU readings at block 5004 to identify and correct for inertial drift, or it may execute the second path to estimate robot pose based on joint encoder readings at block 5014 to identify and compensate for mechanical backlash. Furthermore, both paths can be executed simultaneously to allow the system to verify both sensor types in a single verification cycle. Simultaneously, the BSPM is configured to estimate a robot pose with camera data at block 5020, which serves as the high-confidence reference state. The camera-based pose at block 5020 may serve as the reference because the camera provides absolute position measurements in the world frame that are not subject to the cumulative drift of IMUs or the backlash and compliance errors of encoders.

In alternative implementations, the same hierarchical process 5000 can be configured to adjust camera misalignment or extrinsic parameter errors if the IMUs and/or encoders are ensured to provide highly precise state estimations. In this scenario, the system allows the IMU-based pose estimate from block 5004 and/or the encoder-based pose estimate from block 5014 to serve as the ground truth reference for the visual system. By projecting known robot geometry into the camera frame based on these precise inertial and encoder measurements, the comparison block 5030 can identify discrepancies between where visual features should appear and where they are actually detected in the image stream. If a geometric offset is identified at block 5040, a positioning routine can be configured to update the extrinsic rotation and translation matrices of the robot cameras, thereby correcting for any mechanical shift in the camera housing or lens distortion that may have occurred during operation. In some embodiments, this camera positioning routine may employ a Gauss-Newton or Levenberg-Marquardt solver to minimize the aggregate re-projection error over a buffer of recent camera frames, and the solver may apply damping terms to prevent overcorrection in response to transient measurement outliers.

Following these estimations, the system transitions to a centralized comparison block 5030, where it is configured to compare the IMU-estimated or encoder-estimated poses to the camera-estimated pose. This block functions as a diagnostic gateway to determine if a discrepancy over a threshold exists at block 5040. If the discrepancy remains within acceptable limits, the system allows the robot 1 to continue standard operation by outputting the IMU-or encoder-estimated pose (e.g., the one closer to the camera-estimated pose) at block 5050. However, if a significant discrepancy is detected—for instance, if the IMU-based orientation has drifted beyond a few degrees or if the encoder-based end-effector position deviates from the visual state—the system is configured to output the camera-estimated pose at block 5050 and determine whether the IMU or joint encoders need readjustment or replacement at block 5060. In this routine, the system can use the camera-estimated poses as a ground truth to adjust the IMU biases or adjust the joint encoder offsets and backlash parameters. This loop provides a self-correcting mechanism where visual data acts as the ultimate arbiter, allowing the system to reset the zero-point or bias of internal sensors without external intervention. In further embodiments, the threshold at block 5040 may be adaptive, with the BSPM adjusting the threshold magnitude based on the current operating mode, such that tighter thresholds are enforced during precision manipulation tasks and relaxed thresholds are permitted during gross locomotion or non-contact transit motions. The adaptive threshold may be parameterized as a function of the current task identifier and the estimated payload mass, enabling the system to automatically tighten its tolerance when the robot 1 transitions from a low-precision locomotion phase to a high-precision manipulation phase. In all cases, the output of the process 5000 is position data that is delivered to the onboard AI system for use in controlling the robot's parts and components.

By analyzing visual features in captured image data and correlating them with known reference points or motion patterns, the BSPM can identify and correct biases in joint encoders with a high degree of granularity. For example, by observing the trajectory of a robot hand as it performs a known circular motion, the system can detect subtle deviations from the expected arc that indicate non-linearities in the joint encoders or transmission backlash. This correlation may be accomplished using machine learning-based regression models that learn to map visual error patterns to specific joint angle corrections, or through optimization algorithms like Levenberg-Marquardt that minimize the re-projection error. Iterative refinement techniques, such as gradient descent, can also be employed to progressively adjust the encoder bias parameters until the visually observed pose aligns with the kinematically derived pose from the kinematic model. This allows the system to adapt to mechanical changes, such as the gradual loosening of a joint or the effects of varying payloads on structural compliance. In some embodiments, the BSPM may partition the encoder operation parameters into a static component (e.g., zero-point offset and scale factor) and a configuration-dependent component (e.g., backlash as a function of joint angle and direction of motion), and the machine learning model may learn both components from the visual feedback data. In further embodiments, the BSPM may maintain a lookup table indexed by joint angle and direction of motion that stores the learned backlash compensation value for each operating region, and this lookup table may be updated incrementally during operation as new encoder-camera discrepancy observations become available. In yet further embodiments, the lookup table may be interpolated using a spline or piecewise-linear function to provide smooth backlash compensation values at joint angles between the discrete entries in the table, preventing discontinuous compensation commands that could introduce vibration in the control output.

In some other implementations, the BSPM may implement a three-way fusion of IMU data, encoder data, and robot camera data to determine the position of each of the robot body, limbs, hands, and finger assembly with maximum accuracy and redundancy. This comprehensive fusion provides the most robust position estimation by combining high-rate inertial and encoder measurements with drift-free visual observation. The three sensor modalities provide complementary information at different rates and with different error characteristics: encoders provide high-rate absolute position referenced to actuators, IMUs provide high-rate orientation and dynamics with drift, and cameras provide medium-rate absolute position in world frame with latency. The three-way fusion exploits this complementarity to achieve accuracy and robustness exceeding any two-sensor combination. In some embodiments, the three-way fusion may be extended with data from additional sensor modalities, such as tactile sensors or torque sensors, to form a four-way or five-way fusion that provides even greater redundancy and richer state information during contact-rich manipulation tasks.

The fusion may be implemented using a multi-rate EKF with separate prediction and update stages for each sensor type. At the highest rate (e.g., 1 kHz), encoder measurements update the joint angle estimates. At a slightly lower rate (e.g., 500 Hz), IMU measurements update the orientation and velocity estimates, with consistency constraints linking IMU-derived and encoder-derived joint angles. At the lowest rate (e.g., 60 Hz), camera measurements provide absolute position corrections that remove accumulated drift from both encoders (due to backlash or compliance) and IMUs (due to gyroscope bias). The fusion implements cross-validation between all three sensor pairs: encoder-IMU consistency checks transmission behavior, encoder-camera consistency checks encoder and transmission health, and IMU-camera consistency checks IMU drift and bias estimation. Disagreement in any pair, while the third sensor agrees with one of them, indicates a fault in the disagreeing sensor. This triple-redundant architecture enables continued operation after single-sensor failures and provides high confidence in position estimates when all sensors agree. The fusion computation involves approximately 0.4 to 0.8 milliseconds total for the multi-rate filter updates. In alternative embodiments, the cross-validation logic may be implemented as a bank of hypothesis filters, wherein each filter assumes a different sensor fault scenario, and the BSPM selects the hypothesis with the highest likelihood to determine the current sensor health state and apply the corresponding corrections. The bank of hypothesis filters may include at least one filter for each possible single-sensor fault and one filter for a no-fault state, and the system may transition between hypotheses using a Bayesian model selection criterion that evaluates the posterior probability of each hypothesis given the observed sensor data. In further embodiments, the bank of hypothesis filters may include compound fault hypotheses that account for the simultaneous degradation of two or more sensors, providing robustness against correlated failure modes that might arise from a shared cause such as a power supply anomaly, a thermal event, or an electromagnetic interference source.

In further embodiments, the multi-rate EKF may include a graceful degradation mode in which, upon detection of a sensor fault, the filter seamlessly transitions to a reduced-order state estimation using the remaining healthy sensors, maintaining operational continuity with a quantified increase in estimation uncertainty rather than halting the robot's task execution. The system may log each sensor fault event along with the detected fault type, duration, and impact on estimation accuracy, enabling fleet-level reliability analytics that inform sensor selection and placement decisions for future robot designs. Regardless of whether the fusion operates with all three sensors or in a degraded mode, the resulting position estimates are delivered to the onboard AI system for use in controlling the robot's parts and components. In some embodiments, the graceful degradation mode may also notify the onboard AI system of the increased estimation uncertainty, enabling the AI system to reduce the aggressiveness of its control actions, select alternative motion plans that avoid regions of the workspace with poor observability, or request human operator oversight for tasks that demand positioning accuracy beyond what the degraded sensor suite can provide.

x. Encoder Data and IMU Data

In some other implementations, the BSPM may fuse data from the encoders with data from the IMUs to determine the position of each finger assembly with high accuracy and low latency, combining the absolute position sensing of encoders with the high-bandwidth motion sensing of IMUs. This combination addresses the limitations of each sensor type when used alone. The encoders measure the angular position of each joint (e.g., at the motor shaft, intermediate transmission shaft, or joint output) and provide absolute position information without drift, but are limited to measuring rotation about the joint axis and may be affected by transmission compliance or backlash, which can introduce errors between the motor position and the actual joint position. The IMUs measure the full 3-DOF orientation of each finger assembly and provide high-bandwidth dynamic response, but accumulate drift due to gyroscope bias, making them unsuitable for long-term absolute positioning. By fusing encoder and IMU data, the BSPM may achieve the absolute accuracy of the encoders with the bandwidth and full-orientation sensing of the IMUs, exploiting the complementary strengths of both sensor types. The fused estimate may capture rapid transient motions that would be attenuated by encoder filtering while maintaining long-term stability. In some embodiments, the fusion may weight the encoder contribution more during slow or quasi-static motions where the encoder provides the most accurate information, and weight the IMU contribution more during fast dynamic motions where the high bandwidth of the IMU captures transients that the encoder path may attenuate through mechanical filtering. The weighting may be implemented as a velocity-dependent blending function that smoothly transitions between the encoder-dominant and IMU-dominant regimes based on the estimated joint velocity magnitude.

For example, in a tightly-coupled fusion approach, the EKF state vector includes the joint angle, joint velocity, orientation quaternion, angular velocity, and gyroscope bias for each finger assembly, providing a complete kinematic description. The process model propagates the orientation using gyroscope measurements and propagates the joint angle using either the gyroscope-derived joint-axis rotation or a commanded velocity, where the predicted joint velocity equals the component of angular velocity along the joint axis unit vector, ensuring consistency between the orientation and joint angle states. The encoder provides a direct measurement of the joint angle plus measurement noise, and the measurement noise covariance reflects the encoder resolution and any additional error sources. The IMU accelerometer provides a measurement of the gravity vector in the assembly frame during quasi-static motion (as defined above, i.e., when translational accelerations are below the configurable threshold), computed from the rotation matrix corresponding to orientation times the gravity vector plus measurement noise, constraining the orientation estimate. The measurement update fuses both encoder and accelerometer measurements, with the encoder correcting the joint angle estimate and the accelerometer correcting the orientation estimate (specifically, the tilt components perpendicular to the gravity vector), providing complementary corrections. The complementary corrections enable the filter to maintain accuracy across a wide range of operating conditions. In some embodiments, the EKF may implement adaptive measurement noise scaling, wherein the accelerometer noise covariance is increased when the IMU detects linear accelerations exceeding the quasi-static threshold (indicating that dynamic acceleration is corrupting the gravity reference), and decreased when the assembly is in a quasi-static state, providing context-dependent weighting of the gravity observation. The adaptive scaling may employ a chi-squared test on the measurement innovation to detect when the accelerometer data is corrupted by dynamic acceleration, triggering an automatic increase in the accelerometer noise covariance for the duration of the dynamic event.

For joints with mechanical compliance between the encoder location and the joint output (e.g., series elastic actuators, harmonic drives, or tendon transmissions), the IMU-encoder fusion enables estimation of the compliance deflection and thereby the joint torque, providing force sensing without dedicated torque sensors. The relationship between the motor-side angle, the link-side angle, and the compliance deflection involves the gear ratio and compliance stiffness, with the deflection proportionate to the transmitted torque. As a first-order approximation, the joint torque estimate equals the stiffness times the compliance deflection estimate, following the linear relationship described by Hooke's law. For transmissions exhibiting significant nonlinear stiffness, hysteresis, or friction—as is common in harmonic drives and tendon transmissions—the compliance model may be extended as described in the nonlinear embodiment below. The encoder measures the motor angle, while the IMU measures the actual link orientation from which the link angle may be derived, and the difference between these angles reflects the compliance deflection. This approach enables joint torque estimation without dedicated torque sensors and provides a means for detecting external contacts when the estimated compliance deflection deviates from the expected value based on commanded motor torque, offering redundant force sensing. The encoder-IMU fusion computation involves approximately 0.05 to 0.2 milliseconds per joint, enabling sub-millisecond latency for state estimation that supports high-bandwidth control. The low latency enables stable control at loop rates exceeding 1 kHz. In alternative embodiments, the compliance model may be extended beyond a linear stiffness to include nonlinear stiffness characteristics, damping, and hysteresis, and the EKF may estimate these nonlinear parameters online by observing the relationship between the measured deflection and the applied torque over a range of operating conditions. In a further embodiment, the estimated joint torque may be provided to the BSPM as an auxiliary input channel during self-positioning, enabling the BSPM to compensate for load-dependent kinematic deflections by correlating the measured torque at each joint with the observed visual deviation from the nominal kinematic model. In yet further embodiments, the nonlinear compliance model may be represented as a piecewise-linear function or a neural network that maps the deflection and deflection rate to the estimated torque, and this model may be trained or updated using supervised learning from episodes in which the robot 1 applies known torques to external force-torque sensors, providing ground-truth torque labels for the training data.

When dual encoders are present (e.g., one at the motor shaft and one at the joint output), the fusion with IMU data provides additional redundancy and enables explicit measurement of transmission compliance and backlash, providing rich information about the transmission state. The motor-side encoder and joint-side encoder may have different resolutions and noise characteristics, which are captured in their respective measurement noise covariances, enabling optimal weighting of the two encoder signals. The EKF may include separate state variables for motor angle and joint angle, with the transmission dynamics modeled to include link inertia, transmission stiffness, transmission damping, and any external torque from contact, capturing the dynamic behavior of the transmission. The IMU data provides an independent observation of the joint angle and joint velocity, constraining the filter estimate and improving the estimation of external torque, enhancing the accuracy and reliability of the state estimation. The triple-redundant position sensing (motor encoder, joint encoder, and IMU) provides robust fault detection capability. In some embodiments, the BSPM may implement a backlash model within the transmission dynamics that represents the dead-zone region in which the motor-side angle can change without producing a corresponding change in the joint-side angle, and the filter may estimate the backlash width as a state variable that adapts over time to account for mechanical wear. The estimated backlash width may be trended over time and compared against a maximum allowable threshold, and if the threshold is exceeded, the system may generate a maintenance alert indicating that the transmission associated with the affected joint is approaching end-of-life and should be inspected or replaced during the next scheduled maintenance window. In further embodiments, the maintenance alert may include a recommended replacement timeline computed from the current backlash width, the historical rate of backlash growth, and the maximum allowable backlash for the affected joint's operational role, enabling predictive maintenance scheduling that minimizes unplanned downtime. In yet further embodiments, the system may correlate the backlash growth rate with operational variables such as cumulative joint cycles, peak torque history, and operating temperature, enabling the predictive maintenance model to refine its remaining-useful-life estimate based on the specific loading history of each joint rather than a fleet-average degradation curve.

### F. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.” It should be understood that any parameter that disclosed a range herein may be set to any value within that range, and/or may set a smaller range within the larger disclosed range. For example, disclosing a range between 10 million and 2 trillion parameters discloses a range from 1 billion to 50 billion parameters. Further, disclosing a range between 100 mHz to 50 Hz discloses a range from 1 Hz to 50 Hz.

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a Delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), wheeled robots with torsos and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/352,959, 19/355,393, 19/321,022, 19/355,531, 19/355,786, 19/357,879, 19/358,414, and 19/362,617; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A method for determining the position and orientation of parts and components of a humanoid robot using a body self-perception model (BSPM), the method comprising:
receiving, by the BSPM executing on one or more processors of the humanoid robot, image data from a plurality of vision sensors mounted on the humanoid robot, the plurality of vision sensors comprising at least a first camera mounted in a head of the humanoid robot and a second camera mounted on or near a hand of the humanoid robot;
processing, by the BSPM, the image data to detect and localize a plurality of keypoints on parts and components of the humanoid robot, wherein each keypoint corresponds to a visually distinguishable feature on a component of the humanoid robot or around a joint of the humanoid robot;
determining, by the BSPM, from the detected keypoints, a six-degree-of-freedom pose comprising a position and an orientation for each of one or more tracked parts or components of the humanoid robot; and
providing the determined six-degree-of-freedom pose of each of the one or more tracked parts or components to an onboard AI system of the humanoid robot, wherein the onboard AI system uses the determined pose to generate motor commands for controlling the position and movement of the parts and components of the humanoid robot in a closed-loop control cycle.

2. The method of claim 1, wherein the BSPM determines the six-degree-of-freedom pose using a weighted combination of a keypoint-based estimation and a holistic pose estimation, and wherein a relative weighting between the keypoint-based estimation and the holistic pose estimation is dynamically adjusted based on a degree of occlusion detected in a current image frame.

3. The method of claim 2, wherein the degree of occlusion is estimated by comparing a number of detected keypoints against an expected number of keypoints for a given part when fully visible, and wherein a ratio of detected to expected keypoints is used to compute a weighting factor that governs the relative contribution of the holistic pose estimation and the keypoint-based estimation.

4. The method of claim 1, wherein the BSPM expresses the determined pose using a delta SE(3) pose representation in which a pose update is expressed as a six-dimensional vector in the Lie algebra se(3), the six-dimensional vector comprising a three-dimensional translational component in R³ and a three-dimensional rotational component parameterized in the Lie algebra so(3) of the rotation group.

5. The method of claim 1, wherein the BSPM outputs an uncertainty estimate associated with each determined pose, the uncertainty estimate comprising a 6×6 covariance matrix defined over an SE(3) tangent space, and wherein the onboard AI system modulates a velocity of movement commands based on the uncertainty estimate such that lower-velocity commands are generated when the uncertainty estimate indicates lower positional confidence and higher-velocity commands are generated when the uncertainty estimate indicates higher positional confidence.

6. The method of claim 5, wherein the uncertainty estimate is propagated through a kinematic chain of the humanoid robot such that the uncertainty of a distal component reflects accumulated uncertainties of all proximal joints and links, providing the onboard AI system with a measure of end-effector positional confidence.

7. The method of claim 1, further comprising:
computing, by the BSPM, first and second time derivatives of the determined pose from a temporal sequence of images, the first time derivative comprising a spatial velocity represented as a twist vector in SE(3) and the second time derivative comprising a spatial acceleration; and
providing the first and second time derivatives to the onboard AI system to enable predictive control strategies that anticipate a future spatial state of the tracked parts or components.

8. The method of claim 1, wherein the BSPM continuously determines the positions and poses of the parts and components during task execution by the humanoid robot without a dedicated calibration routine, and wherein the continuous position determination establishes a closed-loop control cycle in which the BSPM determines a position, the onboard AI system generates motor commands based on the determined position, the parts move in response to the motor commands, and the BSPM determines a new position in a next cycle.

9. The method of claim 1, further comprising:
fusing, by the BSPM, the image data with sensor data from one or more additional sensors of a different modality than the plurality of vision sensors to produce a fused position estimate, the one or more additional sensors selected from the group consisting of inertial measurement units, joint encoders, time-of-flight sensors, and event-based vision sensors,
wherein the fused position estimate is provided to the onboard AI system in place of or in combination with the determined six-degree-of-freedom pose.

10. A humanoid robot system comprising:
a humanoid robot body comprising a torso, a head, a plurality of limbs, and a plurality of end effectors;
a plurality of vision sensors mounted on the humanoid robot body, the plurality of vision sensors comprising at least a first camera and a second camera positioned at different locations on the humanoid robot body;
one or more additional sensors of a different modality than the plurality of vision sensors, the one or more additional sensors selected from the group consisting of inertial measurement units, joint encoders, time-of-flight sensors, and event-based vision sensors;
one or more processors configured to execute a body self-perception model (BSPM), the BSPM configured to:
receive image data from the plurality of vision sensors and sensor data from the one or more additional sensors,
determine a six-degree-of-freedom pose of each of a plurality of tracked components of the humanoid robot body from the image data by detecting and localizing keypoints on the tracked components,
fuse the image data with the sensor data from the one or more additional sensors using a sensor fusion algorithm to produce a fused position estimate for each of the plurality of tracked components, the fused position estimate having an accuracy exceeding what either the image data or the sensor data alone can achieve, and deliver the fused position estimate to an onboard AI system; and
the onboard AI system configured to receive the fused position estimate and to generate motor commands for controlling the position and movement of the plurality of tracked components of the humanoid robot body based on the fused position estimate.

11. The humanoid robot system of claim 10, wherein the one or more additional sensors comprise inertial measurement units (IMUs) mounted on articulated segments of the end effectors, and wherein the BSPM fuses IMU data with the image data using an Extended Kalman Filter (EKF) that maintains a state vector comprising an orientation, an angular velocity, a position, a linear velocity, and a gyroscope bias for each articulated segment.

12. The humanoid robot system of claim 11, wherein the EKF implements a multi-step prediction and update architecture in which a prediction step propagates an orientation state using bias-corrected angular velocity at an IMU update rate, and an update step utilizes gravity vector observations during quasi-static phases to correct accumulated integration errors, and wherein the quasi-static phases are identified when a translational acceleration of the humanoid robot is below a configurable threshold.

13. The humanoid robot system of claim 10, wherein the one or more additional sensors comprise joint encoders, and wherein the BSPM fuses joint encoder data with the image data by:
mapping expected visual keypoint locations based on current encoder angles using a forward kinematic model;
comparing the expected visual keypoint locations to observed keypoints detected in the image data; and
attributing persistent discrepancies between the expected and observed keypoint locations to kinematic biases, transmission backlash, or thermal expansion, and applying a correction to the forward kinematic model.

14. The humanoid robot system of claim 13, wherein the BSPM maintains a running history of encoder-camera discrepancies over a sliding time window, classifies a detected discrepancy pattern into one of a set of predefined categories comprising linear drift, periodic oscillation, step change, and random noise, and selects a correction strategy based on the classified category.

15. The humanoid robot system of claim 10, wherein the BSPM further comprises:
a vision memory module that maintains a short-term visual memory by composing features from a sequence of recent video frames and that implements a learned temporal attention mechanism assigning different weights to each frame in the sequence based on relevance to a current position determination; and
a state and force memory that augments the fused position estimate with a history of recent proprioceptive states and force feedback, the state and force memory comprising a learned anomaly detector that triggers a protective response when a current force profile deviates from an expected distribution for a given action.

16. A method for controlling movement of a finger assembly of a humanoid robot, the method comprising:
obtaining, by an AI model executing on one or more processors of the humanoid robot, first inertial measurement data from a first inertial measurement unit (IMU) mounted on a first articulated segment of the finger assembly;
obtaining, by the AI model, second inertial measurement data from a second IMU mounted on a second articulated segment of the finger assembly, the second articulated segment being different from the first articulated segment;
fusing, by the AI model, the first inertial measurement data and the second inertial measurement data to determine a pose of the finger assembly, comprising reconstructing a kinematic chain of the finger assembly from the first articulated segment through the second articulated segment relative to a gravity vector and a reference frame of a palm of the humanoid robot;
determining, from the fused first and second inertial measurement data, a position and an orientation of a fingertip of the finger assembly; and
providing the determined position and orientation to an onboard AI system of the humanoid robot, wherein the onboard AI system generates motor commands that control movement of the finger assembly based on the determined position and orientation.

17. The method of claim 16, wherein the first IMU and the second IMU each comprise a micro-electromechanical systems (MEMS) accelerometer and a MEMS gyroscope, and wherein the BSPM fuses the first inertial measurement data and the second inertial measurement data using an Extended Kalman Filter (EKF) having a state vector that includes, for each of the first articulated segment and the second articulated segment, an orientation represented as a quaternion, an angular velocity, and a gyroscope bias.

18. The method of claim 17, wherein the EKF propagates an orientation state of each articulated segment using bias-corrected angular velocity from the respective IMU, and wherein the EKF corrects accumulated drift using gravity vector observations during quasi-static motion phases in which a translational acceleration of the respective articulated segment is below a configurable threshold.

19. The method of claim 16, further comprising:
obtaining image data from one or more cameras mounted on the humanoid robot;
estimating, by the AI model, a camera-based pose of the finger assembly from the image data;
comparing the pose determined from the fused first and second inertial measurement data against the camera-based pose; and
when a discrepancy between the IMU-determined pose and the camera-based pose exceeds a threshold, readjusting one or more bias parameters of the first IMU or the second IMU based on the camera-based pose to correct for accumulated drift.

20. The method of claim 16, wherein a compliance deflection at a joint between the first articulated segment and the second articulated segment is estimated from a difference between a motor-side angle measured by an encoder and a link-side orientation derived from the second IMU, and wherein a joint torque is estimated from the compliance deflection and a stiffness of the joint without a dedicated torque sensor, and wherein the estimated joint torque is provided as an auxiliary input to the AI model to compensate for load-dependent deflections of the finger assembly.
